(19) United States
(12) Patent Application Publication
(10) Pub. No.: US 2026/0308453 A1
(43) Pub. Date: Oct. 8, 2026

(54) POLYMERIZABLE LIQUID CRYSTAL COMPOSITION

(71) Applicant: ROLIC TECHNOLOGIES AG, Allschwil (CH)

(72) Inventors: Sabrina CHAPPELLET, Allschwil (CH); Richard FRANTZ, Allschwil (CH)

(73) Assignee: ROLIC TECHNOLOGIES AG, Allschwil (CH)

(21) Appl. No.: 19/475,893

(22) PCT Filed: Apr. 10, 2024
(86) PCT No.: PCT/EP2024/059682

§ 371 Date: Oct. 16, 2025

(30) Foreign Application Priority Data
May 12, 2023 (EP) 23173022.7

(51) Int. Cl. C09K 19/54; C09K 19/04; C09K 19/34

(52) U.S. Cl. CPC C09K 19/54; C09K 19/3452; C09K 19/3497; C09K 2019/0448

(57) ABSTRACT

A polymerizable liquid crystal composition comprising (i) a polymerizable liquid crystal compound capable of exhibiting birefringence of reverse wavelength dispersibility when the polymerizable liquid crystal compound is in an oriented state, and (ii) a polymerization initiator, which is represented by the following formula (I)

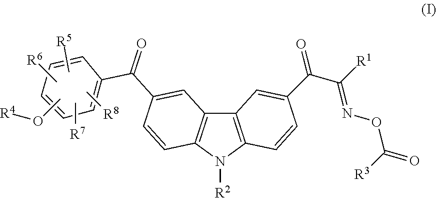

exhibits a favorable high temperature stability. A liquid crystal film, which may be obtained via curing of the polymerizable product, is useful in the manufacture of an optical device or an electro-optical device.

The present invention provides a polymerizable liquid crystal composition, a cured liquid crystal film that is a cured product of the polymerizable liquid crystal composition, a process for manufacturing the cured liquid crystal film, and the use of the liquid crystal film in the manufacture of an optical or an electro-optical device.

There is a need for anisotropic liquid crystal films that exhibit negative optical retardation dispersion. For example, a quarter wave film made with negative dispersion birefringent materials will be largely achromatic. Devices such as a reflective LCD that utilizes such a quarter wave film will have a dark state that is not colored.

WO 2021/037774 relates to a composition for optical films comprising at least two anisotropic liquid crystalline compounds. The optical films show a reverse retardation pattern of polarized light over a wide wavelength band.

A cured liquid crystal film formed from a liquid crystal composition containing a polymerizable liquid crystal (LCP) compound is usually formed by aligning the polymerizable liquid crystal compound in a liquid crystal state on an alignment substrate to obtain a polymerizable liquid crystal layer in which the molecules have a predetermined orientation, and polymerizing the liquid crystals to form a network wherein the orientation of the liquid crystals is immobilized. The film wherein the orientation of the liquid crystals is immobilized can be removed from the alignment substrate and can be transferred to another substrate, e.g., by using an adhesive.

In many cases, polymerization is induced by irradiating light, such as ultraviolet rays, and a photopolymerization initiator is used as the polymerization initiator.

WO 2021/175855 discloses α-oxo oxime ester compounds based on carbazole derivatives that have specific substituent groups useful as photopolymerization initiators.

Liquid crystal polymer (LCP) materials, while stable at room temperature, can degrade when subjected to increased temperature. In particular, optical properties like the retardance decrease and, hence, the performance of the LC film degrades over time.

The reason for the degradation is not fully elucidated. However, it may at least in part be attributed to low polymerization rate and high content of free radicals. A polymerizable liquid crystal compound whose polymer can exhibit reverse wavelength dispersion has a maximum absorption in the wavelength region of active energy rays, generally represented by ultraviolet rays, cleaving the photopolymerization initiator. Part of the active energy ray irradiated to the polymerizable liquid crystal compound is absorbed by the polymerizable liquid crystal compound, which tends to hinder the cleavage of the photopolymerization initiator, making it difficult to achieve a high polymerization rate.

In order to increase the polymerization rate of such a polymerizable liquid crystal compound, it is necessary to irradiate a high-intensity active energy ray in consideration of the absorption of the active energy ray by the polymerizable liquid crystal compound. As a result, structural destruction of the polymerizable liquid crystal compound and accompanying alignment defects tend to occur, and it may be difficult to impart high optical properties to the resulting liquid crystal film.

Therefore, there is a demand for LCP compositions for the preparation of aligned polymer films showing a favorable high temperature stability.

The present invention provides a polymerizable liquid crystal composition comprising (i) a polymerizable liquid crystal compound capable of exhibiting birefringence of reverse wavelength dispersibility when the polymerizable liquid crystal compound is in an oriented state, and (ii) a polymerization initiator, which is represented by the following formula (I)

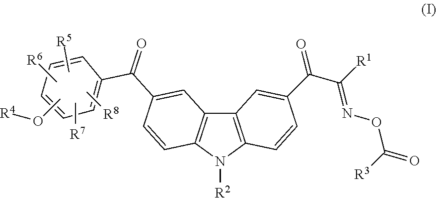

wherein
R¹ is hydrogen, C₁-C₂₀-alkyl, C₁-C₆-alkyl-C₃-C₆-cycloalkyl, C₃-C₂₀-cycloalkyl, or C₂-C₁₂-alkenyl, wherein C₃-C₂₀-cycloalkyl or C₂-C₁₂-alkenyl is uninterrupted or interrupted by one or more O, S, CO, NR¹⁰ or COOR⁴; or
R¹ is C₁-C₂₀alkyl which is unsubstituted or substituted by one or more halogen, OR⁴, SR⁹, NR¹⁰R¹¹, COOR⁴ CONR¹⁰R¹¹, CN, PO(OR^{3a})₂, S(O)ₘ—R^{3a},

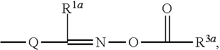

C₃-C₈cycloalkyl which is uninterrupted or interrupted by one or more O, S, CO or NR¹⁰; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR⁴, SR⁹, NR¹⁰R¹¹, PO(OR^{3a})₂ or S(O)ₘ—R^{3a}; or
R¹ is C₂-C₂₀alkyl which is interrupted by one or more O, CO, S, C(O)O, OC(O), SO, SO₂, phenylene, naphthylene or NR¹⁰, wherein the interrupted C₂-C₂₀alkyl is unsubstituted or substituted by one or more halogen, C₃-C₈cycloalkyl, OH, SH, OR⁴, SR⁹, COOR⁴, O(CO)—R^{3a}, CONR¹⁰R¹¹, NR¹⁰R¹¹, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR⁴, SR⁹ or NR¹⁰R¹¹; or
R¹ is C₆-C₂₀aryl or C₃-C₂₀heteroaryl each of which is unsubstituted or substituted by one or more C₁-C₂₀alkyl, phenyl, halogen, C₁-C₄haloalkyl, CN, NO₂, OR⁴, SR⁹, NR¹⁰R¹¹, COOR⁴, (CO)—R^{3a}, (CO)NR¹⁰R¹¹, PO(OR^{3a})₂, S(O)ₘ—R^{3a} or group

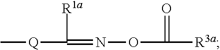

or by one or more C₂-C₂₀alkyl which is interrupted by one or more O, S, or NR¹⁰; or by one or more C₁-C₂₀alkyl which is unsubstituted or substituted by one or more halogen, COOR⁴, CONR¹⁰R¹¹, phenyl, C₃-C₈cycloalkyl, C₃-C₂₀heteroaryl, C₆-C₂₀aryloxycarbonyl, C₃-C₂₀heteroaryloxycarbonyl, OR⁴, SR⁹ or NR¹⁰R¹¹; or by one or more phenyl, naphthyl, benzoyl or naphthoyl, each of which is unsubstituted or substituted by OR⁴, SR⁹ or NR¹⁰R¹¹; or
R¹ is C₂-C₂₀alkanoyl or benzoyl which is unsubstituted or substituted by one or more C₁-C₆alkyl, phenyl, OR⁴, SR⁹ or NR¹⁰R¹¹; or
R¹ is C₂-C₁₂alkoxycarbonyl optionally interrupted by one or more —O— and/or optionally substituted by one or more hydroxyl groups; or
R¹ is phenoxycarbonyl which is unsubstituted or substituted by C₁-C₆ alkyl, halogen, phenyl, OR⁴, SR⁹ or NR¹⁰R¹¹; or
R¹ is CN, (CO)—R^{3a}, COOR⁴, CONR¹⁰R¹¹, NO₂, PO(OR^{3a})₂ or S(O)ₘ—R^{3a};
R^{1a} is hydrogen, C₁-C₂₀alkyl, CN, (CO)—R^{3a}, COOR^{4a}, CONR^{10a}R^{11a}, NO₂, PO(OR^{3a})₂ or S(O)ₘ—R^{3a}; or
R^{1a} is C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}; or
R^{1a} is C₁-C₂₀alkyl interrupted by one or more O, S, NR^{10a}, CO, SO or SO₂, which is unsubstituted or substituted by C₃-C₈cycloalkyl, OH, SH, O(CO) R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{1a} is C₂-C₁₂alkenyl or C₃-C₂₀cycloalkyl, each of which is uninterrupted or interrupted by one or more O, S, CO, NR^{10a} or COOR^{4a}; or
R^{1a} is C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a} CONR^{10a}R^{11a} PO(OR^{3a})₂ or S(O)ₘ—R^{3a}; or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}; or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}:
R² is hydrogen, C₁-C₂₀-alkyl or C₁-C₆-alkyl-C₃-C₆-cycloalkyl which is unsubstituted or substituted by one or more halogen, OR⁴, SR⁹, COOR⁴CONR¹⁰R¹¹, NR¹⁰R¹¹, PO(OR^{3a})₂, COR^{3a}, or
R² is C₂-C₂₀alkyl or C₁-C₆alkyl-C₃-C₆-cycloalkyl which is interrupted by one or more O, CO, S, C(O)O, OC(O), SO, SO₂, phenylene, naphthylene or NR¹⁰; wherein the interrupted C₂-C₂₀alkyl is unsubstituted or substituted by one or more halogen, OR⁴, SR⁹, COOR⁴, CONR¹⁰R¹¹, NR¹⁰R¹¹; or
R² is C₂-C₄hydroxyalkyl, C₂-C₁₀alkoxyalkyl, C₃-C₈alkenyl, C₃-C₈cycloalkyl, phenyl-C₁-C₃alkyl, C₂-C₈alkanoyl, C₃-C₁₂alkenoyl, benzoyl; or
R² is C₆-C₂₀aryl or C₃-C₂₀heteroaryl each of which is unsubstituted or substituted by one or more C₁-C₁₂alkyl, C₁-C₄haloalkyl, phenyl, halogen, CN, NO₂, OR⁴, SR⁹, NR¹⁰R¹¹, (CO)—R^{3a}, or by C₂-C₂₀alkyl which is interrupted by one or more O, S, or NR¹⁰, or each of which is substituted by one or more C₁-C₂₀alkyl which is unsubstituted or substituted by one or more halogen, COOR⁴, CONR¹⁰R¹¹, phenyl, C₃-C₈cycloalkyl, C₃-C₂₀heteroaryl, C₆-C₂₀aryloxycarbonyl, C₃-C₂₀heteroaryloxycarbonyl, OR⁴, SR⁹ or NR¹⁰R¹¹; or
R² is a group

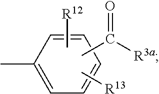

R³ is hydrogen or C₁-C₂₀-alkyl; or
R³ is C₁-C₂₀alkyl substituted by one or more halogen, OR⁴, SR⁹, NR¹⁰R¹¹, CN, COOR⁴, CONR¹⁰R¹¹, C₃-C₈cycloalkyl which is uninterrupted or interrupted by one or more O, S, CO or NR¹⁰; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR⁴, SR⁹ or NR¹⁰R¹¹; or
R³ is C₁-C₂₀alkyl interrupted by one or more O, S, NR¹⁰, CO, SO or SO₂, which is unsubstituted or substituted by C₃-C₈cycloalkyl, OH, SH, O(CO)—R^{3a}, COOR⁴, CONR¹⁰R¹¹C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR⁴, SR⁹ or NR¹⁰R¹¹; or
R³ is C₂-C₁₂alkenyl or C₃-C₂₀cycloalkyl, each of which is uninterrupted or interrupted by one or more O, S, CO, NR¹⁰ or COOR⁴; or
R³ is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR⁴, SR⁹, NR¹⁰R¹¹, COOR⁴, (CO)—R^{3a} or SO₂—R^{3a}; or
R³ is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R³ is C₁-C₂₀alkoxy, which is interrupted by one or more O, S, NR¹⁰, CO, SO or SO₂; or
R³ is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR⁴, SR⁹, NR¹⁰R¹¹, COOR⁴, (CO)—R^{3a} or SO₂—R^{3a};
R^{3a} is hydrogen or C₁-C₂₀-alkyl; or
R^{3a} is C₁-C₂₀alkyl substituted by one or more halogen, OR^{4a}, SR^{9a}, NR^{10a}R^{11a}, CN, COOR^{4a}, CONR^{10a}R^{11a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a} or NR^{10a}R^{11a}; or
R^{3a} is C₁-C₂₀alkyl interrupted by one or more O, S, NR^{10a}, CO, SO or SO₂, which is unsubstituted or substituted by C₃-C₈cycloalkyl, OH, SH, O(CO)—(C₁-C₈alkyl), COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{3a} is C₂-C₁₂alkenyl or C₃-C₂₀cycloalkyl, each of which is uninterrupted or interrupted by one or more O, S, CO, NR^{10a} or COOR^{4a}; or
R^{3a} is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3a} is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R^{3a} is C₁-C₂₀alkoxy, which is interrupted by one or more O, S, NR^{10a}, CO, SO or SO₂; or
R^{3a} is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3a} is a group

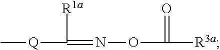

R^{3b} is hydrogen or C₁-C₂₀alkyl; or
R^{3b} is C₁-C₂₀alkyl substituted by one or more halogen, OR^{4a}, SR^{9a}, NR^{10a}R^{11a}, CN, COOR^{4a}, CONR^{10a}R^{11a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a} or NR^{10a}R^{11a}; or
R^{3b} is C₁-C₂₀alkyl interrupted by one or more O, S, NR^{10a}, CO, SO or SO₂, which is unsubstituted or substituted by C₃-C₈cycloalkyl, OH, SH, O(CO)—(C₁-C₈alkyl), COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{3b} is C₂-C₁₂alkenyl or C₃-C₂₀cycloalkyl, each of which is uninterrupted or interrupted by one or more O, S, CO, NR^{10a} or COOR^{4a}; or
R^{3b} is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3b} is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R^{3b} is C₁-C₂₀alkoxy, which is interrupted by one or more O, S, NR^{10a}, CO, SO or SO₂; or
R^{3b} is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl);
R⁴ is hydrogen, (CO)—R^{3a}, COOR^{4a}, CO NR^{10a}R^{11a}, S(O)ₘ—R^{3a} or PO(OR^{3a})₂; or
R⁴ is C₁-C₂₀alkyl, which is substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}; or
R⁴ is C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R⁴ is C₂-C₁₂alkenyl or C₃-C₂₀cycloalkyl, each of which is uninterrupted or interrupted by one or more O, S, CO, NR^{10a} or COOR^{4a}; or
R⁴ is C₆-C₂₀aryl, which is substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group

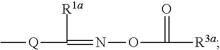

or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}; or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}; or
R⁴ is C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group

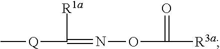

or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}; or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}; or
R⁴ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄haloalkyl, CN, phenyl, C₁-C₂₀alkylphenyl, C₁-C₈alkoxyphenyl,

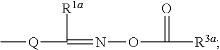

or C₃-C₂₀cycloalkyl which is uninterrupted or interrupted by one or more O, S, CO or NR^{10a};
R^{4a} is hydrogen, C₁-C₂₀-alkyl, (CO)O(C₁-C₈-alkyl) or CON(C₁-C₈-alkyl)₂; or
R^{4a} is C₁-C₂₀alkyl substituted by one or more halogen, OH, SH, CN, C₃-C₈alkenoxy, OCH₂CH₂CN, OCH₂CH₂(CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{4a} is C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{4a} is C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₃alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈)₂, phenyl or benzoyl;
R^{4a} is C₂-C₁₂alkenyl, (CO)O(C₁-C₈alkenyl) or C₃-C₈cycloalkyl, each of which is uninterrupted or interrupted by one or more O, S, CO, N(C₁-C₈alkyl) or COO(C₁-C₈alkyl); or
R^{4a} is C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino;
R⁵, R⁶, R⁷ and R⁸ independently of each other are hydrogen, C₁-C₂₀-alkyl, C₆-C₂₀-aryl, C₁-C₂₀-alkoxy, C₆-C₂₀-aryl C₁-C₂₀-alkyl, hydroxyl-C₁-C₂₀-alkyl, hydroxyl-C₁-C₂₀-alkoxy-C₁-C₂₀-alkyl, C₃-C₁₀-cycloalkyl, amino, CN, NO₂, hydroxy,

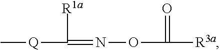

(CO)—R^{3a}, OR^{4a} or COOR⁴;
R⁹ is hydrogen or C₁-C₂₀alkyl; or
R⁹ is C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}; or
R⁹ is C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R⁹ is C₂-C₁₂alkenyl or C₃-C₂₀cycloalkyl, each of which is uninterrupted or interrupted by one or more O, S, CO, NR^{10a} or COOR^{4a}; or
R⁹ is C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group

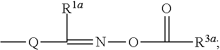

or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}; or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}; or
R⁹ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄haloalkyl, CN, phenyl, C₁-C₂₀alkylphenyl, C₁-C₈alkoxyphenyl,

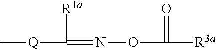

or C₃-C₂₀cycloalkyl which is uninterrupted or interrupted by one or more O, S, CO or NR^{10a};
R^{9a} is hydrogen or C₁-C₂₀alkyl; or
R^{9a} is C₁-C₂₀alkyl substituted by one or more halogen, OH, SH, CN, C₃-C₈alkenoxy, OCH₂CH₂CN, OCH₂CH₂ (CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{9a} is C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{9a} is C₂-C₁₂alkenyl or C₃-C₈cycloalkyl, each of which is uninterrupted or interrupted by one or more O, S, CO, N(C₁-C₈alkyl) or COO(C₁-C₈alkyl); or
R^{9a} is C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₈alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈)₂, phenyl or benzoyl; or
R^{9a} is C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino;
R¹⁰ and R¹¹ independently of each other are hydrogen, C₁-C₂₀-alkyl, S(O)ₘ—R^{3a}, O(CO)—R^{3a} (CO)—R^{3a} or CONR^{10a}R^{11a}; or
R¹⁰ and R¹¹ independently of each other are C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}; or
R¹⁰ and R¹¹ independently of each other are C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R¹⁰ and R¹¹ independently of each other are C₂-C₁₂alkenyl or C₃-C₂₀cycloalkyl, each of which is uninterrupted or interrupted by one or more O, S, CO, NR^{10a} or COOR^{4a}; or
R¹⁰ and R¹¹ independently of each other are C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a} CONR^{10a}R^{11a}, PO(OR^{3a})₂, S(O)ₘ—R^{3a} or group

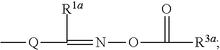

or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}; or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}; or
R¹⁰ and R¹¹ independently of each other are C₁-C₂₀alkoxy, which is unsubstituted or substituted by one or more halogen, phenyl, C₁-C₈alkylphenyl or C₁-C₈alkoxyphenyl; or
R¹⁰ and R¹¹ independently of each other are C₁-C₂₀alkoxy, which is interrupted by one or more O, S, NR^{10a}, CO, SO or SO₂; or
R¹⁰ and R¹¹ independently of each other are C₆-C₂₀aryloxy or C₃-C₂₀heteroaryloxy, each of which is unsubstituted or substituted by one or more halogen, C₁-C₈alkyl, C₁-C₄haloalkyl, phenyl, C₁-C₈alkylphenyl, C₁-C₈alkoxyphenyl, CN, NO₂, OR^{4a}, SR^{9a}, NR^{10a}R^{11a}, COOR^{4a}, (CO)—R^{3a} or SO₂—R^{3a}; or
R¹⁰ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄-haloalkyl, CN, phenyl, C₁-C₂₀alkylphenyl, C₁-C₈alkoxyphenyl,

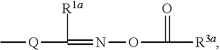

or C₃-C₂₀cycloalkyl which is uninterrupted or interrupted by one or more O, S, CO or NR^{10a}; or
R¹⁰ and R¹¹ together with the N-atom to which they are attached form a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄-haloalkyl, CN, phenyl,

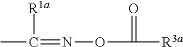

or C₃-C₂₀cycloalkyl which is uninterrupted or interrupted by one or more O, S, CO or NR^{10a};
R^{10a} and R^{11a} independently of each other are hydrogen, C₁-C₂₀alkyl, S(O)ₘ—(C₁-C₈alkyl), O(CO)(C₁-C₈alkyl), (CO)(C₁-C₈alkyl), (CO)O(C₁-C₈alkyl) or CON(C₁-C₈alkyl)₂; or
R^{10a} and R^{11a} independently of each other are C₁-C₂₀alkyl substituted by one or more halogen, OH, SH, CN, C₃-C₈alkenoxy, OCH₂CH₂CN, OCH₂CH₂ (CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{10a} and R^{11a} independently of each other are C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{10a} and R^{11a} independently of each other are C₂-C₁₂alkenyl or C₃-C₈cycloalkyl, each of which is uninterrupted or interrupted by one or more O, S, CO, N(C₁-C₈alkyl) or COO(C₁-C₈alkyl); or
R^{10a} and R^{11a} independently of each other are C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₃alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈alkyl)₂, phenyl or benzoyl; or
R^{10a} and R^{11a} independently of each other are C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino; or
R^{10a} and R^{11a} independently of each other are C₁-C₂₀alkoxy, which is unsubstituted or substituted by one or more halogen, phenyl, C₁-C₈alkylphenyl or C₁-C₈alkoxyphenyl; or
R^{10a} and R^{11a} independently of each other are C₁-C₂₀alkoxy, which is interrupted by one or more O, S, N(C₁-C₈alkyl), CO, SO or SO₂; or
R^{10a} and R^{11a} independently of each other are C₆-C₂₀aryloxy or C₃-C₂₀heteroaryloxy, each of which is unsubstituted or substituted by one or more halogen, C₁-C₈alkyl, C₁-C₄haloalkyl, phenyl, C₁-C₈alkylphenyl, C₁-C₈alkoxyphenyl, CN, NO₂, C₁-C₈alkoxy, C₁-C₈alkylsulfanyl, N(C₁-C₈alkyl)₂, CO(OC₁-C₈alkyl), (CO)—(C₁-C₈alkyl) or SO₂—(C₁-C₈alkyl); or
R^{10a} and R^{11a} together with the N-atom to which they are attached form a 5- or 6-membered saturated or unsaturated ring which is uninterrupted or interrupted by O, S or N(C₁-C₈alkyl), and which 5- or 6-membered saturated or unsaturated ring is unsubstituted or substituted by one or more C₁-C₈alkyl, C₁-C₈alkoxy, C₁-C₈alkylsulfanyl, N(C₁-C₈alkyl)₂, NO₂, halogen, C₁-C₄haloalkyl, CN, phenyl or C₃-C₂₀cycloalkyl which is uninterrupted or interrupted by one or more O, S, CO or N(C₁-C₈alkyl);
R¹² and R¹³ independently of each other are hydrogen, C₁-C₁₂alkyl optionally substituted by one or more halogen, phenyl, CN, —OH, —SH, C₁-C₄alkoxy, (CO)OH or (CO)O(C₁-C₄alkyl); or
R¹² and R¹³ are phenyl optionally substituted by one or more C₁-C₆alkyl, halogen, CN, OR⁴, SR⁹ or NR¹⁰R¹¹; or
R¹² and R¹³ are halogen, CN, OR⁴, SR⁹, SOR⁹, SO₂R⁹ or NR¹⁰R¹¹, wherein the substituents OR⁴, SR⁹ or NR¹⁰R¹¹ optionally form 5- or 6-membered rings via the radicals R⁴, R⁹, R¹⁰ and/or R¹¹ with one of the carbon atoms of the phenyl, naphthyl, benzoyl or naphthoyl group or that of the substituent R^{3a}; or
R¹² and R¹³ together are a group

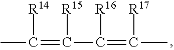

wherein R¹⁴, R¹⁵, R¹⁶ and R¹⁷ independently of one another are hydrogen, C₁-C₁₂alkyl optionally substituted by one or more halogen, phenyl, CN, —OH, —SH, C₁-C₄alkoxy, (CO)OH or (CO)O(C₁-C₄alkyl); or R¹⁴, R¹⁵, R¹⁶ and R¹⁷ are phenyl optionally substituted by one or more C₁-C₆alkyl, halogen, CN, OR⁴, SR⁹ or NR¹⁰R¹¹; or R¹⁴, R¹⁵, R¹⁶ and R¹⁷ are halogen, CN, OR⁴, SR⁹ or NR¹⁰R¹¹; or
R¹² and R¹³ together are a group

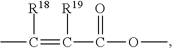

wherein R¹⁸ and R¹⁹ independently of each other are hydrogen, C₁-C₁₂alkyl optionally substituted by one or more halogen, phenyl, CN, —OH, —SH, C₁-C₄alkoxy, (CO)OH or (CO)O(C₁-C₄alkyl); or R¹⁸ and R¹⁹ are phenyl optionally substituted by one or more C₁-C₆alkyl, halogen, CN, OR⁴, SR⁹ or NR¹⁰R¹¹;
m is 1 or 2; and
Q is CO or a direct bond.

The polymerization initiator is a carbazole-based α-oxo oxime ester compound according to formula (I).

In a preferred embodiment, R¹ is C₁-C₂₀alkyl, C₁-C₆alkyl-C₃-C₆cycloalkyl, C₃-C₂₀cycloalkyl; or
R¹ is C₂-C₂₀alkyl which is interrupted by one or more O, CO, S, C(O)O, OC(O), SO, or SO₂; or
R¹ is C₆-C₂₀aryl which is unsubstituted or substituted by one or more C₁-C₂₀alkyl.

In a particularly preferred embodiment, R¹ is C₁-C₂₀alkyl, preferably linear C₁-C₈alkyl, in particular linear C₂-C₆-alkyl.

In a preferred embodiment, R² is C₁-C₂₀alkyl; or
R² is C₂-C₂₀alkyl or C₁-C₆alkyl-C₃-C₆-cycloalkyl which is interrupted by one or more O, CO, S, C(O)O, OC(O), SO or SO₂; or
R² is C₆-C₂₀aryl which is unsubstituted or substituted by one or more C₁-C₁₂alkyl or (CO)—R^{3a}.

In a particularly preferred embodiment, R² is C₂-C₁₀alkyl.

In another preferred embodiment, R³ is hydrogen or C₁-C₂₀-alkyl, preferably C₁-C₂₀-alkyl, in particular linear C₁-C₂₀-alkyl, such as linear C₁-C₆-alkyl, most preferably methyl.

In another preferred embodiment, R^{3a} is C₁-C₂₀-alkyl; or
R^{3a} is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl).

In a particularly preferred embodiment, R^{3a} is C₁-C₂₀-alkyl, preferably R^{3a} is C₁-C₁₀alkyl.

In another preferred embodiment, R⁴ is (CO)—R^{3a}, COOR^{4a}, CONR^{10a}R^{11a}, S(O)ₘ—R^{3a} or PO(OR^{3a})₂, in particular (CO)—R^{3a}.

In another preferred embodiment, R^{4a} is C₁-C₂₀-alkyl, C₆-C₂₀aryl or C₃-C₂₀heteroaryl.

In a particularly preferred embodiment, R^{4a} is C₁-C₂₀-alkyl, preferably C₁-C₈-alkyl.

In another preferred embodiment, R⁵, R⁶, R⁷ and R⁸ independently of each other are hydrogen or C₁-C₂₀-alkyl.

In a particularly preferred embodiment, R⁵, R⁶, R⁷ and R⁸ are hydrogen.

In another preferred embodiment, R⁹ is hydrogen or C₁-C₂₀-alkyl.

In a particularly preferred embodiment, R⁹ is hydrogen or C₁-C₈-alkyl.

In another preferred embodiment, R¹⁰ and R¹¹ independently of each other are hydrogen, C₁-C₂₀-alkyl, S(O)ₘ—R^{3a}, O(CO)—R^{3a} (CO)—R^{3a} or CONR^{10a}R^{11a}.

In a particularly preferred embodiment, R¹⁰ and R¹¹ independently of each other are hydrogen or C₁-C₈-alkyl.

In another preferred embodiment, R^{10a} and R^{11a} independently of each other are hydrogen, C₁-C₂₀alkyl, S(O)ₘ—(C₁-C₈alkyl), O(CO)(C₁-C₈alkyl), (CO)(C₁-C₈alkyl), (CO)O(C₁-C₈alkyl) or CON(C₁-C₈alkyl)₂.

In a particularly preferred embodiment, R^{10a} and R^{11a} independently of each other are hydrogen or C₁-C₈-alkyl.

In one embodiment, the compound of formula (I) is a compound wherein
R¹ is hydrogen, C₁-C₂₀-alkyl, C₁-C₆-alkyl-C₃-C₆-cycloalkyl, C₃-C₂₀-cycloalkyl, or C₂-C₁₂-alkenyl, wherein C₃-C₂₀-cycloalkyl or C₂-C₁₂-alkenyl is uninterrupted or interrupted by one or more O, S, CO, NR¹⁰ or COOR⁴;
R² is hydrogen, C₁-C₂₀-alkyl or C₁-C₆-alkyl-C₃-C₆-cycloalkyl which is unsubstituted or substituted by one or more halogen, OR⁴, SR⁹, COOR⁴CONR¹⁰R¹¹, NR¹⁰R¹¹, PO(OR^{3a})₂, COR^{3a};
R³ is hydrogen or C₁-C₂₀-alkyl;
R^{3a} is hydrogen or C₁-C₂₀-alkyl;
R⁴ is hydrogen, (CO)—R^{3a}, COOR^{4a}, CONR^{10a}R^{11a}, S(O)ₘ—R^{3a} or PO(OR^{3a})₂;
R^{4a} is hydrogen, C₁-C₂₀-alkyl, (CO)O(C₁-C₈-alkyl) or CON(C₁-C₈-alkyl)₂;
R⁵, R⁶, R⁷ and R⁸ independently of each other are hydrogen, C₁-C₂₀-alkyl, C₆-C₂₀-aryl, C₁-C₂₀-alkoxy, C₆-C₂₀-aryl C₁-C₂₀-alkyl, hydroxyl-C₁-C₂₀-alkyl, hydroxyl-C₁-C₂₀-alkoxy-C₁-C₂₀-alkyl, C₃-C₁₀-cycloalkyl, amino, CN, NO₂, hydroxy,

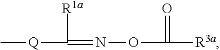

(CO)—R^{3a}, OR^{4a} C₂₀-alkyl, C₃-C₁₀-cycloalkyl, amino, CN, NO₂, hydroxy, or COOR⁴;
R⁹ is hydrogen or C₁-C₂₀-alkyl;
R¹⁰ and R¹¹ independently of each other are hydrogen, C₁-C₂₀-alkyl, S(O)ₘ—R^{3a}, O(CO)—R^{3a} (CO)—R^{3a} or CONR^{10a}R^{11a}; and
R^{10a} and R^{11a} independently of each other are hydrogen, C₁-C₂₀alkyl, S(O)ₘ—(C₁-C₈alkyl), O(CO)(C₁-C₈alkyl), (CO)(C₁-C₈alkyl), (CO)O(C₁-C₈alkyl) or CON(C₁-C₈alkyl)₂; and
Q is CO or a direct bond.

Preferred compounds of the formula (I) include compounds of formula (Ia) and (Ib):

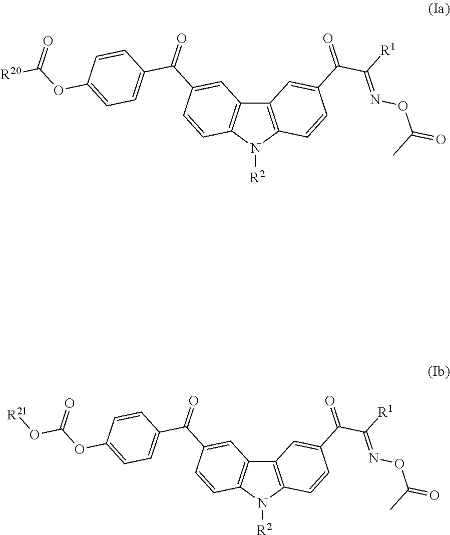

wherein
R¹ is linear C₁-C₈alkyl, in particular C₂-C₆alkyl;
R²⁰ and R²¹ independently of each other are C₁-C₂₀alkyl, C₆-C₂₀aryl or C₃-C₂₀heteroaryl, in particular C₁-C₈-alkyl.

A particularly preferred compound of formula (Ia) is the compound of formula (Ia-1):

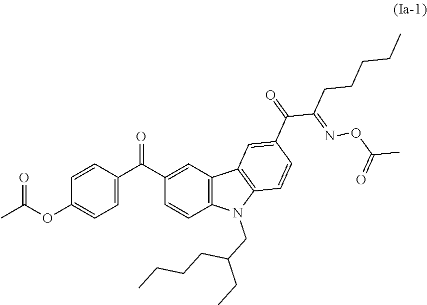 [SMILES: CCCCC/C(=N\OC(C)=O)C(=O)c1ccc2c(c1)c1cc(C(=O)c3ccc(OC(C)=O)cc3)ccc1n2CC(CC)CCCC]

The polymerizable liquid crystal composition preferably comprises the polymerization initiator of formula (I) in an amount of 0.015 to 10 wt.-%, more preferably 0.5 to 8.0 wt.-%, even more preferably 1.0 to 6.0 wt.-%, and most preferably 1.5 to 4.0 wt.-%, relative to the total weight of the polymerizable liquid crystal composition.

Suitable α-oxo oxime ester compounds are known to the skilled person. The synthesis of such compounds is described, e.g., in WO 2021/175855. For example, the compound of formula (I) can be prepared by reaction of the corresponding oximes with an acyl halide, in particular a chloride, or an anhydride in an inert solvent such as for example t-butyl methyl ether (TBME), tetrahydrofurane (THF), dimethoxyethane (DME), dimethylacetamide (DMA), dichloromethane (DCM), ethyl acetate or dimethylformamide (DMF) in the presence of a base or a mixture of bases, for example triethylamine or pyridine, or in a basic solvent such as pyridine, as indicated in the following scheme:

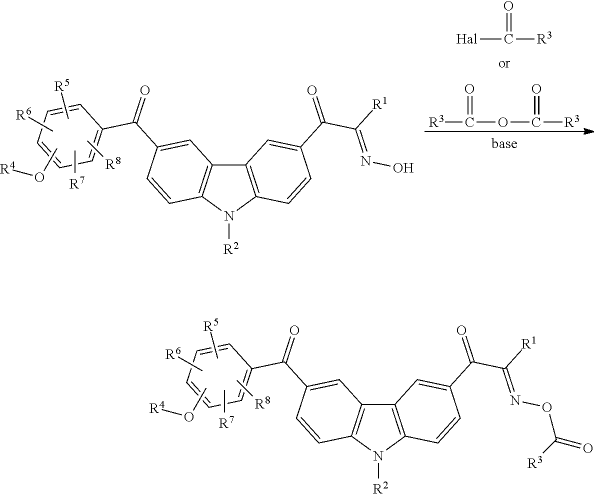

R¹ to R⁸ have the meanings as given above, and R³ is preferably methyl. Hal means a halogen atom, in particular Cl. Such reactions are described, e.g., in WO 201/2045736, and are generally carried out at temperatures of −15 to +50° C., preferably 0 to 25° C.

The α-ketoximes required as starting materials can be obtained by a variety of methods described in standard chemistry textbooks (for instance in J. March, Advanced Organic Chemistry, 4th Edition, Wiley Interscience, 1992), or in specialized monographs, for example, S. R. Sandler & W. Karo, Organic functional group preparations, Vol. 3, Academic Press. One of the most convenient methods is, for example, the nitrosation of “active” methylene groups with nitrous acid or an alkyl nitrite. Both alkaline conditions, as described for example in Organic Synthesis coll. Vol. VI (J. Wiley & Sons, New York, 1988), pp 199 and 840, and acidic conditions, as described, for example, in Organic Synthesis coll. Vol. V, pp 32 and 373, coll. Vol. III, pp 191 and 513, coll. Vol. II, pp 202, 204 and 363, are suitable for the preparation of the oximes used as starting materials in the invention. Nitrous acid is usually generated from sodium nitrite. The alkyl nitrite can be for example methyl nitrite, ethyl nitrite, isopropyl nitrite, butyl nitrite, amyl nitrite, or isoamyl nitrite.

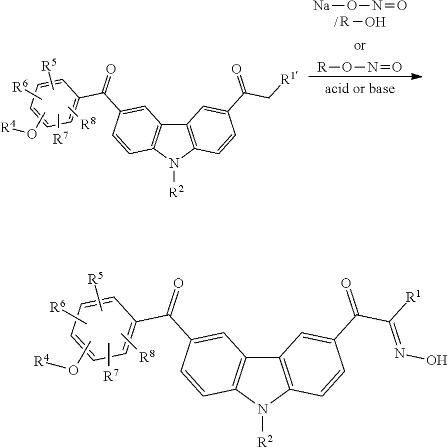

The corresponding ketone intermediates are for example prepared by the methods described in the literature, for example, in standard chemistry textbooks (for instance in J. March. Advanced Organic Chemistry, 4th Edition, Wiley Interscience, 1992). In addition, successive Friedel-Crafts reaction is effective for synthesis of the intermediates. Such reactions are well known to those skilled in the art.

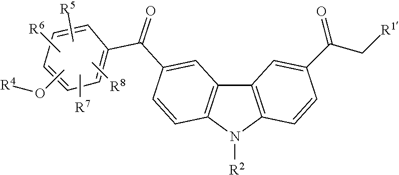

The corresponding ketone intermediates can be synthesized, for example, by the following method, but are not limited thereto. A plausible synthetic scheme is described as follows. Arylation and acylation of [A], and demethylation reaction of [B] give the corresponding ketone intermediate [C] Coupling reaction of [C] with [D] gives the corresponding ketone intermediate [E] Alternatively, [D] can be introduced after the subsequent oximation or oxime esterification (Scheme 1).

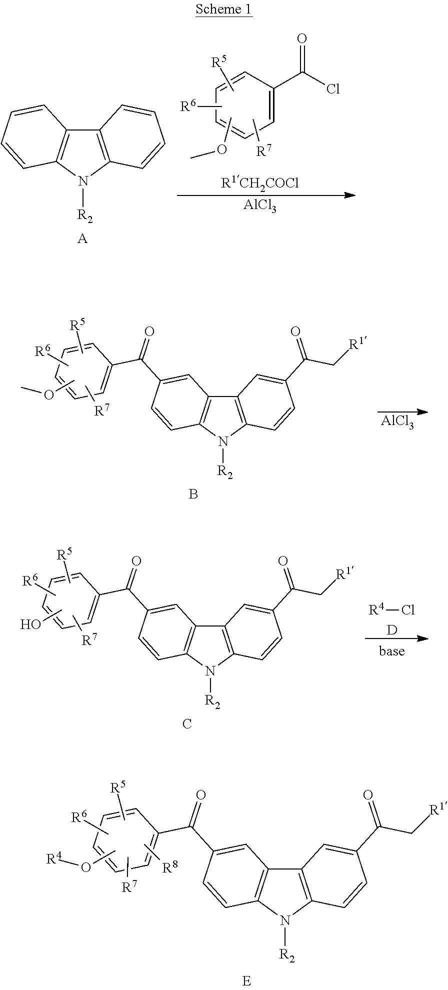

The polymerizable liquid crystal composition comprises a polymerizable liquid crystal compound capable of exhibiting birefringence of reverse wavelength dispersibility when the polymerizable liquid crystal compound is in an oriented state.

Useful parameters for assessing birefringence of reverse wavelength dispersibility in a material are the Re₄₅₀ value, indicating the retardation of the material at a wavelength of 450 nm, the Re₅₅₀ value, indicating the retardation of the material at a wavelength of 550 nm, and the Re₆₅₀ value, indicating the retardation of the material at a wavelength of 650 nm. The retardation Re (in nm) of a material is defined as the product of birefringence Δn at a given wavelength and layer thickness d (in nm).

In a material having birefringence of reverse wavelength dispersion, the value of Re₄₅₀/Re₅₅₀ is below 1.0 and the value of Re₆₅₀/Re₅₅₀ is above 1.0, meaning that the magnitude of the birefringence Δn increases with increasing wavelength λ.

An anisotropic layer formed by uniformly orienting only the polymerizable liquid crystal compound with reverse wavelength dispersion of the polymerizable liquid crystal composition satisfies the relationships: the value of Re₄₅₀/Re₅₅₀ is below 1.0 and the value of Re₆₅₀/Re₅₅₀ is above 1.0.

The polymerizable liquid crystal compound with reverse wavelength dispersion includes in its molecule a main chain mesogen and a side chain mesogen bonded to the main chain mesogen, an optical axis of the main chain mesogen and an optical axis of the side chain mesogen being oriented in different directions when the polymerizable liquid crystal compound with reverse wavelength dispersion is uniformly oriented.

The polymerizable liquid crystal compound is preferably at least one anisotropic compound of formula (II)

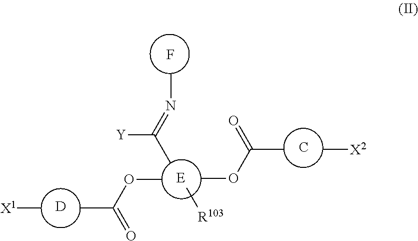

wherein
moieties C and D are independently from each other selected from the group consisting of phenyl, biphenyl, naphthyl, cycloalkyl, bicycloalkyl,

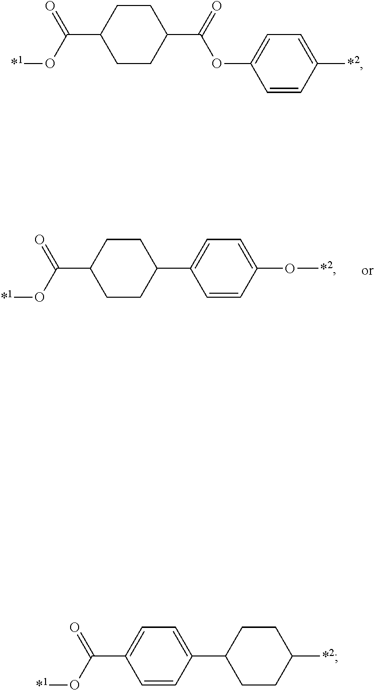

wherein *¹ represents the binding site of moiety C to X² and moiety D to X¹, respectively, and *² represents the binding site of moieties C and D to their neighbouring carboxyl groups bound to moiety E;
moiety E is selected from the group consisting of phenyl, biphenyl and naphthyl; moiety F is selected from the group consisting of the groups of formulae (IIIa), (IIIb) or (IIIc)

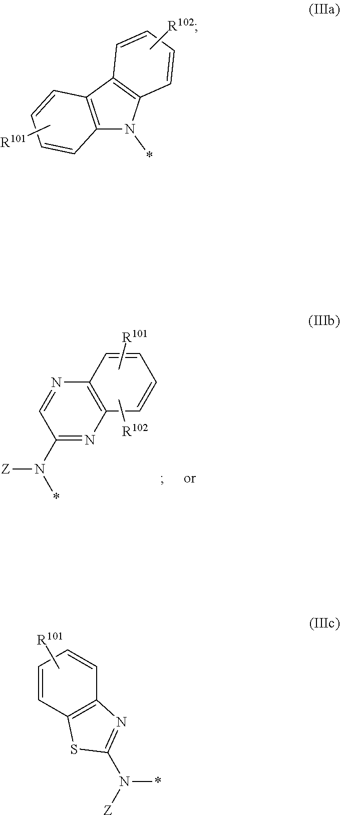

wherein * represents the binding site of moiety F to the imine nitrogen atom of formula II;
wherein at least one of X¹ and X² independently from each other are represented by the group of formula (IV)

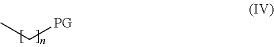

wherein n is an integer between 0 and 24, and wherein one or more C atoms may be replaced by —O—, —COO—, —OCO—, —OOC—, —O(CO)O—, —N—, —NR^{a}—, —CON—, wherein R^{a} is a C₁-C₁₂-alkyl group; and
PG represents a polymerizable group selected from the group consisting of CH₂═C(Ph)-, CH₂═CW—COO—, CH₂═CH—COO-Ph-, CH₂═CW—CO—NH—, CH₂═CH—O—, CH₂═CH—OOC—, Ph-CH═CH—, CH₂═CH-Ph-, CH₂═CH-Ph-O—, R^{b}-Ph-CH═CH—COO—, R^{b}—OOC—CH═CH-Ph-O— and 2-W-epoxyethyl; in which W represents H, Cl, Ph or a lower alkyl and R^{b} represents a lower alkyl with the proviso that when R^{b} is attached to a phenylene group (-Ph-) it may also represent hydrogen or a lower alkoxy,
and, where applicable, X¹ and X² which are not represented by the group of formula (IV) are selected from the group consisting of hydrogen, C₁-C₁₂ substituted or unsubstituted straight or branched alkyl chain, C₃-C₁₂ substituted or unsubstituted straight chain or branched alkenyl chain and C₁-C₁₂-alkoxy, wherein one or more carbon atoms may be replaced by —O—, —COO—, —OCO—, —OOC—, —O(CO)O—, —N—, —NR^{a}—, —CON—, wherein R^{a} is a C₁-C₁₂-alkyl group; Y is selected from the group consisting of H, or substituted or unsubstituted alkyl group having 1 to 12 carbon atoms;
R¹⁰¹, R¹⁰² and R¹⁰³ are independently from each other selected from the group consisting of hydrogen, C₁-C₁₂ straight or branched alkyl chain, C₃-C₁₂-alkenyl, C₁-C₁₂-alkoxy, C₃-C₁₂-alkenyloxy, —(CH₂)ₘ—C(CH₃)₃, NO₂, CN, COR¹⁰⁴, —COOR¹⁰⁴, —OCOR¹⁰⁴, —CONR¹⁰⁵R¹⁰⁴, —NR¹⁰⁵COR¹⁰⁴, OCOOR¹⁰⁴, —OCONR¹⁰⁵R¹⁰⁴, —NR¹⁰⁵COOR¹⁰⁴, —F, —Cl, —CF₃ and —OCF₃; in which m is an integer between 0 and 12;
R¹⁰⁴ is selected from the group consisting of hydrogen, an C₁-C₁₈-alkyl group, an C₃-C₁₈-alkenyl group with the double bond at 3-position or higher, —(CH₂)ₚ—C—(CF₃)₃, CN and unsubstituted or substituted phenyl ring, wherein the substituent of the phenyl ring is selected from the group consisting of C₁-C₆ straight or branched alkyl chain, C₁-C₆-alkoxy, —C—(CH₃)₃, halogen, —CF₃, NO₂, CN, COR¹⁰⁷, —COOR¹⁰⁷, —OCOR¹⁰⁷, —CONR¹⁰⁶R¹⁰⁷, —NR¹⁰⁶COR¹⁰⁷, OCOOR¹⁰⁷, —OCONR¹⁰⁶R¹⁰⁷, —NR¹⁰⁶COOR¹⁰⁷, —F, —Cl, —CF₃ and —OCF₃; in which
R¹⁰⁶ is selected from the group consisting of hydrogen, a lower alkyl group and a lower alkenyl group;
R¹⁰⁷ is selected from the group consisting of hydrogen, an C₁-C₁₈-alkyl group and an C₃-C₁₈-alkenyl group with the double bond at 3-position or higher; p is an integer between 0 and 12;
R¹⁰⁵ is selected from the group consisting of hydrogen, lower alkyl, lower alkenyl and lower alkoxy; and in which n is 0, 1, 2 or 3;
Z is selected from the group consisting of hydrogen, a substituted or unsubstituted alkyl group having 1 to 20 carbon atoms, a substituted or unsubstituted alkenyl group having 2 to 20 carbon atoms, a substituted or unsubstituted cycloalkyl group having 3 to 12 carbon atoms, a substituted or unsubstituted alkynyl group having 2 to 20 carbon atoms, wherein one or more carbon atoms may be replaced by —O—COO—, —OCO—, —OOC—, —O(CO)O—, —N—, —NR^{a}—, —CON—, —CO—R^{b1}, or —NH—R^{c}, wherein R^{a} is a C₁-C₁₂-alkyl group, R^{b}1 and R^{c} are independently from each other a substituted or unsubstituted alkyl group having 1 to 20 carbon atoms, or an organic group having 2 to 30 carbon atoms that includes at least one aromatic ring, or a substituted or unsubstituted alkenyl group having 2 to 20 carbon atoms, or a substituted or unsubstituted cycloalkyl group having 3 to 12 carbon atoms.
The term “lower alkyl” is understood to include C₁-6 branched or straight chained alkyl groups. Examples of lower alkyl groups include methyl, ethyl, propyl, butyl, pentyl and hexyl.
The term “lower alkenyl” is understood to include C₃-6 branched or straight chained alkenyl groups in which the double bond is in 2-position or higher. Examples of lower alkenyl groups include 2-propenyl, 3-butenyl, 3-isopentenyl, 4-pentenyl, 5-hexenyl and 4-isohexenyl.
The term “lower alkoxy” is understood to include C₁-6 achiral, branched or straight chained alkoxy group. Examples of lower alkoxy groups include methoxy, ethoxy, propoxy, butoxy, pentoxy hexoxy and the like.

In one embodiment, the moieties C and D are independently from each other selected from phenyl or cyclohexyl, with the proviso that at least one moiety C or D is phenyl.

In a preferred embodiment, the moiety E is a phenyl ring.

In another embodiment, the moiety F is a group of formula (IIIb) or (IIIc).

In one embodiment, at least one of the moieties C and D is an aromatic ring or contains an aromatic ring and the group of formula (IV) is

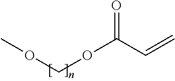

wherein n is an integer between 0 and 24.

Suitable polymerizable liquid crystal compounds are known to the skilled person, e.g., from WO 2020/260621 A1, WO 2021/037774 A1. Preferred polymerizable liquid crystal compounds include:

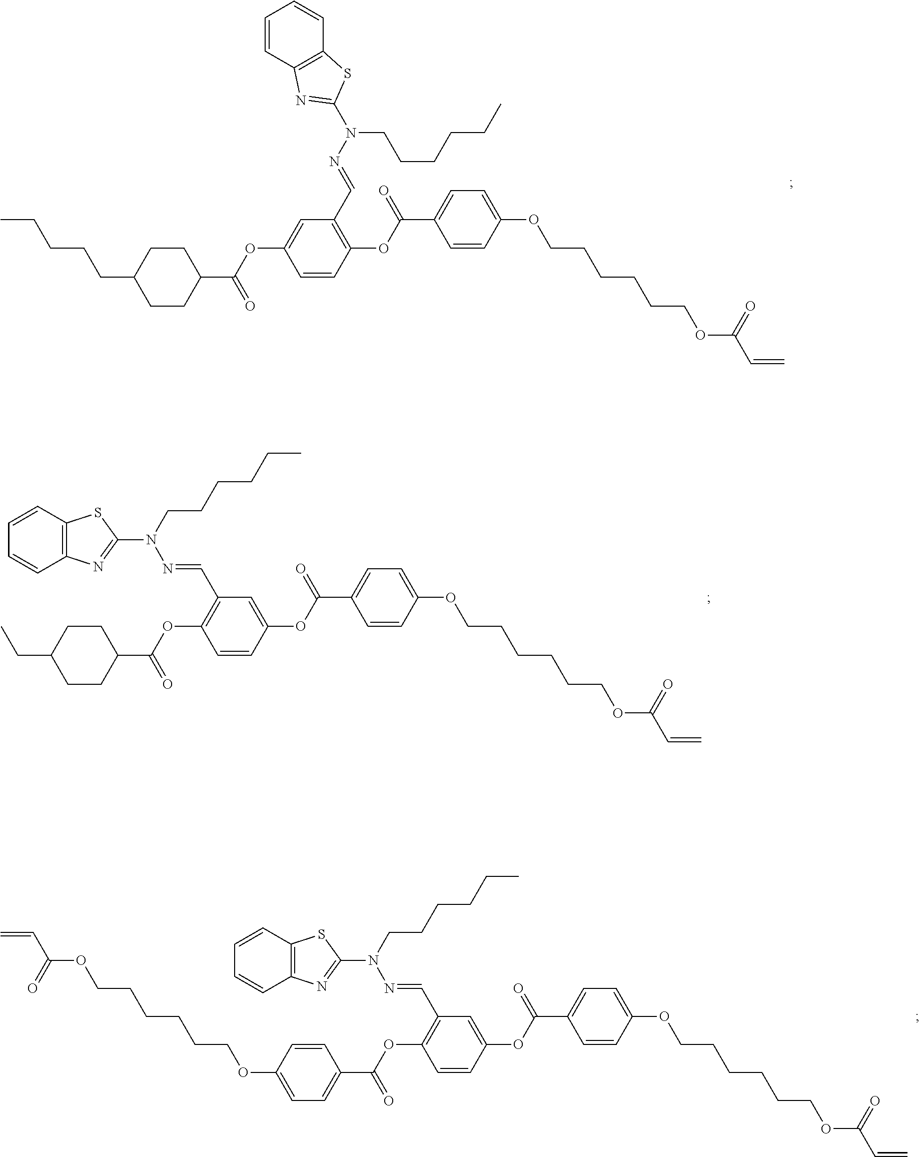

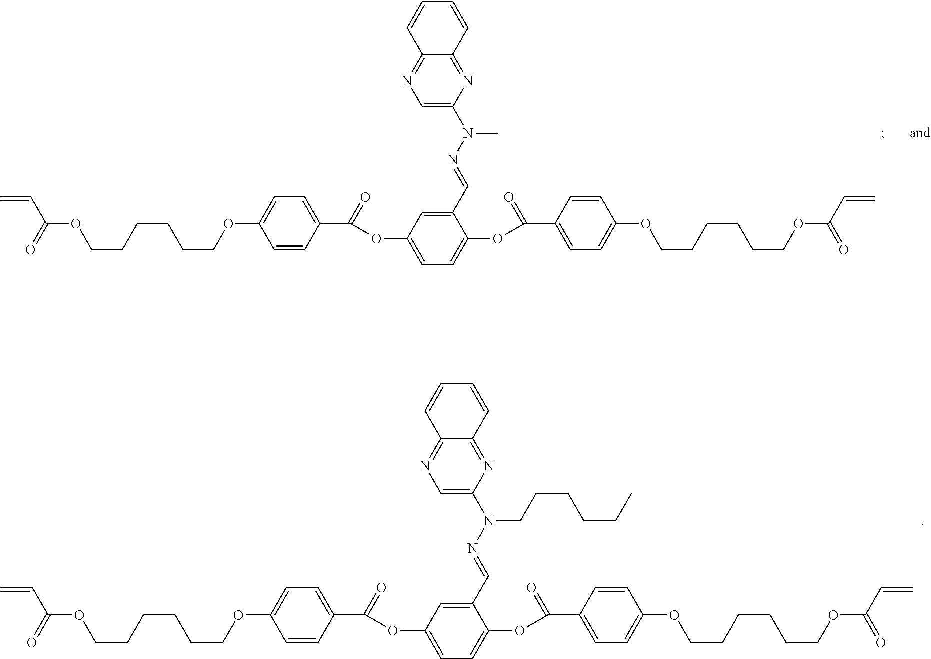

The polymerizable liquid crystal composition preferably comprises the polymerizable liquid crystal compound in an amount of 1.5 to 50 wt.-%, more preferably 5 to 40 wt.-%, even more preferably 8 to 30 wt.-%, and most preferably 10 to 30 wt.-%, relative to the total weight of the polymerizable liquid crystal composition.

The polymerizable liquid crystal composition comprises a polymerizable liquid crystal compound and a polymerization initiator of formula (I). Additionally, the polymerizable liquid crystal composition may comprise at least one solvent and/or at least one additive.

Suitable solvents include ketones such as acetone, cyclopentanone (CP), cyclohexanone (CH), methyl isobutyl ketone (MIBK) and methylethylketone (MEK), amides such as N, N-dimethylformamide (DMF), N-methylpyrrolidone (NMP), N-ethylpyrrolidone, N-vinylpyrrolidone and N,N-dimethylacetamide (AN), ethers such as tetrahydrofuran (THF), dipropylene glycol monomethyl ether, diethylene glycol butyl ether and 1,3-dioxolane (DXG), glycols such as ethylene glycol and dipropylene glycol, esters such as ethylcarbitol acetate, ethyl acetate (EA) 1-methoxy-2-propanol acetate (MPA), γ-butyrolactone (BL), propylene glycol monoacetate and propylene glycol diacetate, organosulfur compounds such as dimethyl sulfoxide (DMSO), and aromatic compounds such as toluene. Preferred solvents include ketones, in particular cyclopentanone (CP), cyclohexanone (CH), methyl isobutyl ketone (MIBK), and methylethylketone (MEK), esters, in particular ethyl acetate (EA) and 1-methoxy-2-propanol acetate (MPA), ethers, in particular 1,3-dioxolane (DXG), organosulfur compounds, in particular dimethyl sulfoxide (DMSO), and aromatic compounds, in particular toluene.

The polymerizable liquid crystal composition preferably comprises a total amount of solvents in the range of 50 to 90 wt.-%, preferably 60 to 80 wt.-%, relative to the total weight of the polymerizable liquid crystal composition.

Suitable additives include antioxidants, accelerators, dyes, polymerization inhibitors, activators, fillers, chain transfer inhibitor, pigments, anti-static agents, flame-retardant agents, thickeners, thixotropic agents, surface-active agents, viscosity modifiers, extending oils, plasticizers, tackifiers, catalysts, sensitizers, stabilizers, lubricating agents, dispersing agents, a polymeric binder and/or monomeric compounds which can be converted into the polymeric binder by polymerization, or, in the case of emulsion coatings and printing inks, a dispersion auxiliary, hydrophobing agents, adhesive agents, flow improvers, leveling agents, defoaming agents, deaerators, diluents, auxiliaries, colorants, dyes and pigments, curing inhibitors, a chiral additive, isotropic or anisotropic fluorescent and/or non-fluorescent dyes, dichroic dyes and crosslinkers.

In order to improve the storage stability, it is preferable to add a polymerization inhibitor to the polymerizable liquid crystal composition. Suitable polymerization inhibitors include aromatic polymerization inhibitors such as 4-tert-butylcatechol (TBC), 4-methoxyphenol (MEHQ), 2,6-di-tert-butyl-4-methylphenol (BHT) and hydroquinone (HQ), in particular 2,6-di-tert-butyl-4-methylphenol (BHT).

Crosslinkers are compounds containing one or more complementary reactive units such as hydroxyl-, thiol-, or amino groups, or one or more polymerizable groups, such as olefinic double bonds, which may react with the polymerizable group(s) of the anisotropic compound of formula (II). For maintaining the liquid crystalline phase, an amount of crosslinker of 0.015 to 10 wt.-%, preferably 0.25 to 3.0 wt.-%, relative to the total weight of the polymerizable liquid crystal composition, is preferred.

Preferably, the crosslinker is selected from mono-, bi- and polyfunctional compounds containing at least one olefinic double bond and polythiols having two or more thiol groups per molecule.

Suitable polythiols include monomeric aliphatic polythiols, oligomeric and polymeric polythiols.

A suitable polymeric polythiol is polypropylene ether glycol bis(β-mercaptopropionate).

Preferred aliphatic dithiols include 1,2-ethanedithiol, butanedithiol, 1,3-propanedithiol, 1,5-pentanedithiol, 2,3-dimercapto-1-propanol, dithioerythritol, 3,6-dioxa-1,8-octanedithiol, 1,8-octanedithiol hexanedithiol, dithiodiglycol, pentanedithiol, decanedithiol, 2-methyl-1,4-butanedithiol, bis-mercaptoethylphenyl methane, 1,9-nonanedithiol(1,9-dimercaptononane), glycol dimercaptoacetate.

Preferred oligomeric dithiols include difunctional mercapto functional urethane oligomers derived from end capping moieties of hydroxyethyl mercaptan, hydroxypropyl mercaptan, dimercaptopropane, dimercapto ethane as described in patent by U.S. Pat. No. 5,744,514.

Preferred trithiol functional compounds include trimethylolethane tris-mercaptopropionate, trimethylolpropane tris-mercaptopropionate (TMPTSH), trimethylolethane tris-mercaptoacetate, and trimethylolpropane tris-mercaptoaacetate glycerol tri(11-mercaptoundecanoate), trimethylol propane tri(11-mercaptoundecate).

Preferred tetrafunctional thiols include pentaerythritol tetrakis(3-mercaptopropionate) (PTMP), pentaerythritol tetramercapto acetate, and pentaeyrthrito tetra(11-mercaptoundecate).

A particularly preferred polythiol crosslinker is pentaerythritol tetrakis(3-mercaptopropionate) (PTMP).

Mono-, bi- and polyfunctional compounds containing at least one olefinic double bond are generally capable of photopolymerization. Examples of such compounds are vinyl esters of carboxylic acids, for example of lauric, myristic, palmitic and stearic acid, and of dicarboxylic acids, for example of succinic acid, adipic acid, allyl and vinyl ethers and methacrylic and acrylic esters of monofunctional alcohols, for example of lauryl, myristyl, palmityl, and stearyl alcohol, and diallyl and divinyl ethers of bifunctional alcohols, for example ethylene glycol and 1,4-butanediol.

Further examples include acrylic acid, methacrylic acid, maleic acid, fumaric acid and itaconic acid, styrene, nucleus-substituted styrene, acrylonitrile, vinyl chloride, vinylidene chloride, vinyl pyridine, N-vinyl pyrrolidone, vinylsulfonic acid, fatty acid vinyl ester, a,b-ethylenic unsaturated carboxylic acid, alkyl ester of (meth)acrylic acid in which the number of carbons of alkyl is 1 to 18, hydroxyalkyl ester of (meth)acrylic acid in which the number of carbons of hydroxyalkyl is 1 to 18, aminoalkyl ester of (meth)acrylic acid in which the number of carbons of aminoalkyl is 1 to 18, ether oxygen-containing alkyl ester of (meth)acrylic acid in which the number of carbons of ether oxygen-containing alkyl is 3 to 18, N-vinylacetamide, p-t-butyl vinyl benzoate, N,N-dimethylaminovinyl benzoate, vinyl benzoate, vinyl pivalate, 2,2-dimethylbutane acid vinyl, vinyl 2,2-dimethylpentanoate, vinyl 2-methyl-2-butanoate, vinyl propionate, vinyl stearate, vinyl 2-ethyl-2-methylbutanate, dicyclopentanyloxylethyl (meth)acrylate, isobornyloxylethyl (meth)acrylate, isobornyl (meth)acrylate, adamanthyl (meth)acrylate, dimethyladamanthyl (meth)acrylate, dicyclopentanyl (meth)acrylate, dicyclopentenyl (meth)acrylate, 2-acryloyloxyethyl succinate, 2-acryloyloxyethylhexahydrophthalic acid, 2-acryloyloxyethyl phthalic acid, 2-acryloyloxyethyl-2-hydroxyethyl phthalic acid, 2-acryloyloxyethyl acid phosphate, 2-methacryloyloxyethyl acid phosphate, mono(meth)acrylate, polypropylene glycol, which has a polymerization degree of 2 to 100, and which is capped by di(meth)acrylate ester or an alkyl group having 1 to 6 carbons, and mono(meth)acrylate ester of a copolymer of polyethylene glycol and, ethylene oxide and polypropylene oxide, and the like are the non-liquid crystalline polymerizable compounds being the monofunctional compound.

Examples of difunctional compounds include 1,4-divinyloxybutane (BDDV), 1,4-butanediol diacrylate, 1,6-hexanediol diacrylate, 1,9-nonanediol diacrylate, neopentyl glycol diacrylate, dimethylol tricyclodecane diacrylate, triethylene glycol diacrylate, dipropylene glycol diacrylate, tripropylene glycol diacrylate, tetraethylene glycol diacrylate, bisphenol A EO-added diacrylate, bisphenol A glycidyl diacrylate, polyethyleneglycol diacrylate and methacrylate.

BDDV is a particularly preferred crosslinker.

Examples of trifunctional or higher-functional polyfunctional compound as pentaerythritol triacrylate, trimethylolpropane triacrylate, trimethylol EO-added triacrylate, trisacryloyloxyethyl phosphate, tris(acryloyloxyethyl) isocyanurate, alkyl-modified dipentaerythritol triacrylate, EO-modified trimethylolpropane triacrylate, PO-modified trimethylolpropane triacrylate, pentaerythritol tetraacrylate, alkyl-modified dipentaerythritol tetraacrylate, ditrimethylolpropanetetraacrylate, dipentaerythritol hexaacrylate, dipentaerythritolmonohydroxypentaacrylate, alkyl-modified dipentaerythritol pentaacrylate, pentaerythritol tri(meth)acrylate, trimethylolpropane tri-(meth)acrylate, trimethylol EO-added tri(meth)acrylate, tris(meth)acryloyloxy ethyl phosphate, tris(meth)acryloyloxy ethyl, isocyanurate, alkyl-modified dipentaerythritol tri(meth)acrylate, EO-modified trimethylolpropane tri(meth)acrylate, PO-modified trimethylolpropane tri(meth)acrylate, pentaerythritol tetra(meth)acrylate, alkyl-modified dipentaerythritol tetra(meth)acrylate, ditrimethylol propanetetra(meth)acrylate, dipentaerythritol hexa(meth)acrylate dipentaerythritolmonohydroxy penta methacrylate and alkyl-modified dipentaerythritol pentamethacrylate. Further examples include dipentaerythritolhexaacrylates wherein the dipentaerythritol is modified with caprolactone, commercially available, e.g., from Nippon Kayaku Co., Ltd. as Kayarad DPCA-20, Kayarad DPCA-30, Kayarad DPCA-60 and Kayarad DPCA-120. Kayarad DPCA-20 is a particularly preferred crosslinker.

In one embodiment, the crosslinker is selected from mono-, bi- and polyfunctional compounds containing at least one olefinic double bond and polythiols which comprise molecules having two or more thiol groups per molecule.

In order to reduce film thickness unevenness when forming a thin film such as an optical anisotropic body or an optical film, it is preferable to add a leveling agent to the polymerizable liquid crystal composition. Suitable leveling agents include silicone-based agents such as modified polydimethylsiloxanes (PDMS), acrylate-based agents such as polyacrylates, fluorocarbon-based agents and hydrocarbon-based leveling agents, in particular polyacrylates such as Tego® Flow, available from Evonik.

The polymerizable liquid crystal composition preferably comprises the leveling agent in an amount of 0.0075 to 2.0 wt.-%, preferably 0.02 to 0.5 wt.-%, relative to the total weight of the polymerizable liquid crystal composition.

Further polymerizable compounds besides the polymerizable liquid crystal compound (i) can be added to the polymerizable liquid crystal composition to increase the mechanical strength of the liquid crystal film, or to increase the chemical resistance, or both. These compounds are preferably mesogenic. Preferably, the further polymerizable compounds are selected from reactive mesogens, most preferably selected from mono- and direactive mesogens.

The term “mesogenic” means a compound comprising one or more calamitic (rod- or board/lath-shaped) or discotic (disk-shaped) mesogenic groups. The term “mesogenic group” means a group with the ability to induce liquid crystal (LC) phase behaviour. The compounds comprising mesogenic groups do not necessarily have to exhibit a liquid crystal phase themselves. It is also possible that they show liquid crystal phase behaviour only in mixtures with other compounds, or when the mesogenic compounds or materials, or the mixtures thereof, are polymerized.

A calamitic mesogenic group typically comprises a mesogenic core consisting of one or more aromatic or non-aromatic cyclic groups connected to each other directly or via linkage groups, optionally comprising terminal groups attached to the ends of the mesogenic core, and optionally comprising one or more lateral groups attached to the long side of the mesogenic core, wherein these terminal and lateral groups may be selected from carbyl or hydrocarbyl groups, polar groups like halogen, nitro, hydroxy, etc., or polymerizable groups. The term “reactive mesogen” (RM) means a polymerizable mesogenic compound. Polymerizable compounds with one polymerizable group are also referred to as “monoreactive” compounds, compounds with two polymerizable groups as “direactive” compounds, and compounds with more than two polymerizable groups as “multireactive” compounds. Examples of such compounds are well-known to the skilled person and are described, e.g., in WO 2018/099883. An example of a further polymerizable compound is [3-methyl-4-[4-(6-prop-2-enoyloxyhexoxy)benzoyl]oxy-phenyl] 4-(6-prop-2-enoyloxyhexoxy)benzoate (FPC-1) shown below.

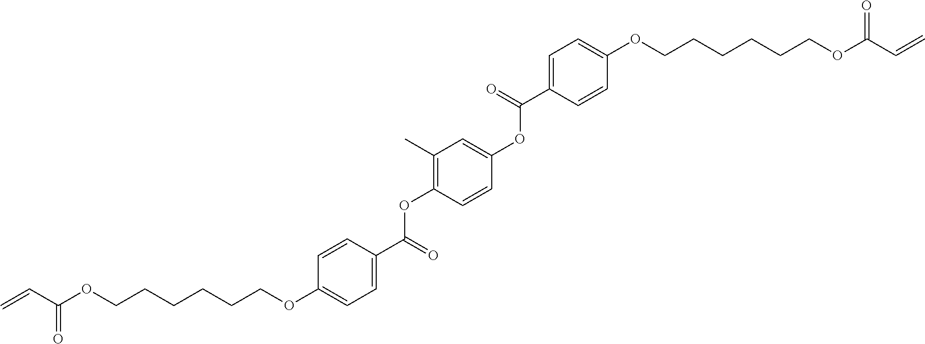 [SMILES: C=CC(=O)OCCCCCCOc1ccc(C(=O)Oc2ccc(OC(=O)c3ccc(OCCCCCCOC(=O)C=C)cc3)c(C)c2)cc1]

The present invention further relates to a liquid crystal film, which is a cured product of the polymerizable liquid crystal composition.

The invention also relates to a process for manufacturing the liquid crystal film, comprising aligning the polymerizable liquid crystal compound to obtain a polymerizable liquid crystal layer in which the polymerizable liquid crystal compound has a predetermined orientation; polymerizing the polymerizable liquid crystal compound to form a network wherein the orientation of the liquid crystals is immobilized; and laminating the liquid crystal film onto a pressure sensitive adhesive coated onto a substrate.

The alignment of the polymerizable liquid crystal composition can be achieved, e.g., by coating an organic solution of the polymerizable liquid crystal composition onto an alignment substrate provided with an alignment layer. The alignment layer usually comprises a photoorientable substance in which anisotropic properties can be induced upon exposure to aligning light. The induced anisotropy suitably provides alignment capability for the polymerizable liquid crystal composition of the invention. The term “alignment direction” refers to the preferred direction that is induced in the polymerizable liquid crystal composition, i.e., the alignment direction is the direction in which the molecules of the liquid crystal are aligned.

Photoorientable substances comprise photoorientable moieties, which are capable of developing a preferred direction upon exposure to aligning light and thus creating anisotropic properties. Such photoorientable moieties preferably have anisotropic absorption properties. Typically, such moieties exhibit absorption within the wavelength range from 230 to 500 nm. Preferably, the photoorientable moieties exhibit absorption of light in the wavelength range from 300 to 450 nm, more preferred are moieties, which exhibit absorption in the wavelength range from 310 to 380 nm.

Preferably, the photoorientable moieties have carbon-carbon, carbon-nitrogen, or nitrogen-nitrogen double bonds.

For example, photoorientable moieties are substituted or un-substituted azo dyes, such as anthraquinone, coumarin, mericyanine, 2-phenylazothiazole, 2-phenylazobenzthiazole, stilbene, cyanostilbene, cinnamonitrile, fluorostilbene, chalcone, cinnamate, cyanocinnamate, stilbazolium, 1,4-bis(2-phenylethylenyl)benzene, 4,4′-bis(arylazo)-stilbene, perylene, 4,8-diamino-1,5-naphthoquinone dyes, aryloxycarboxylic derivatives, arylester, N-arylamide, polyimide, and diaryl ketones having a ketone moiety or ketone derivative in conjugation with two aromatic rings, such as for example substituted benzophenones, benzophenone imines, phenylhydrazones, and semicarbazones.

Preparation of the anisotropically absorbing materials listed above are well known as shown, e.g., by Hoffman et al., U.S. Pat. No. 4,565,424, Jones et al., in U.S. Pat. No. 4,401,369, Cole, Jr. et al., in U.S. Pat. No. 4,122,027, Etzbach et al., in U.S. Pat. No. 4,667,020, and Shannon et al., in U.S. Pat. No. 5,389,285.

Preferably, the photoorientable moieties comprise arylazo, poly(arylazo), stilbene, cyanostilbene, cinnamate or chalcone.

A photoorientable substance may in particular be a monomer, an oligomer or a polymer. The photoorientable moieties can be covalently bonded, for example, within the main chain or within a side chain of a polymer or oligomer or they may be part of a monomer or other compounds, which are not polymerizable. A photoorientable substance may further be a copolymer comprising different types of photoorientable moieties or it may be a copolymer comprising side chains with and without photoorientable moieties.

Polymers denote for example to polyacrylate, polymethacrylate, polyimide, polyurethane, polyamic acids, polymaleinimide, poly-2-chloroacrylate, poly-2-phenylacrylate; unsubstituted or with C₁-C₆-alkyl substituted poylacrylamide, polymethacyrlamide, poly-2-chloroacrylamide, poly-2-phenylacrylamide, polyether, polyvinylether, polyester, polyvinylester, polystyrene-derivatives, polysiloxane, straight-chain or branched alkyl esters of polyacrylic or polymethacrylic acids; polyphenoxyalkylacrylates, polyphenoxyalkylmethacrylates, polyphenylalkylmethacrylates with alkyl residues of 1-20 carbon atoms; polyacrylnitril, polymethacrylnitril, cycloolephinic polymers, polystyrene, poly-4-methylstyrene or mixtures thereof.

A photoorientable substance may also comprise photosensitizers, for example, ketocoumarines and benzophenones.

Further, preferred photoorientable monomers or oligomers or polymers are described in U.S. Pat. Nos. 5,539,074, 6,201,087, 6,107,427, 6,632,909, and 7,959,990.

After the coating, the organic solvent is removed to give a solvent-free liquid crystal layer, in which the molecules have a predetermined orientation.

Alignment of the polymerizable liquid crystal composition can also be achieved by other known means for aligning liquid crystals, e.g., coating of the polymerizable liquid crystal composition onto a substrate that has previously been treated by a rubbing technique.

The polymerizable liquid crystal compound is polymerized to form a network wherein the orientation of the liquid crystals is immobilized.

The steps of polymerizing the polymerizable liquid crystal composition and exposure to aligning light may be in any sequence. Polymerization may be initiated before or after exposure to aligning light or polymerization and exposure may occur simultaneously.

The liquid crystal composition can also be applied on a support and the support may have an aligning surface, which shall mean that the surface has the capability to align liquid crystals. The support may already provide the alignment without further treatment. For example, if a plastic substrate is used as a support, it may provide alignment on the surface due to the manufacturing method, for example extrusion or stretching of the substrate. It is also possible to brush or rub the support or imprint a directional microstructure to generate alignment capability.

The support may be rigid or flexible and can have any form or shape. In principle, it may consist of any material. Preferably, the support comprises plastic, glass or metal or is a silicon wafer. In case the support is flexible, it is preferred that the support is a plastic or metal foil. Preferably, the surface of the support is flat. For some applications, the support may comprise topographical surface structures, such as microstructures like micro lenses or micro-prisms, or structures exhibiting abrupt changes of the shape, such as rectangular structures. Preferably, the support is transparent. The support may also have been subjected to a treatment before coating with polymerizable liquid crystal composition according to the present invention.

The support may be moving during the deposition of the polymerizable liquid crystal composition. For example, a layer of the polymerizable liquid crystal composition may be produced in a continuous roll to roll process by depositing the composition onto a moving flexible foil, which is preferably plastic or metallic. The resulting film may then be wound on a roll together with the support foil or the film may be released from the support and is then wound as a free standing film, without the support.

The support may have additional layers, such as organic, dielectric or metallic layers. The layers can have different functions, for example, an organic layer can be coated as a primer layer, which increases compatibility of the materials to be coated with the support. Metallic layers may be used as electrodes, for example when used in electro-optical devices such as displays, or could have the function as a reflector. The support may also be an optical element or device, which has certain functions, such as a substrate for an LCD, which might comprise, for example, thin film transistors, electrodes or color filters. In another example, the support is a device comprising an OLED layer structure. The support may also be a polarizer, such as a polarizing film or a sheet polarizer, a reflective polarizer, such as the commercially available Vikuity™ DBEF film.

The polymerizable liquid crystal composition may be applied onto the substrate by general coating and printing methods known in the art. Coating methods are for example spin coating, blade coating, knife coating, reverse-roll coating, transfer roll coating, gravure roll coating, kiss roll coating, cast coating, spray coating, slot-orifice coating, calendar coating, electrodepositing coating, dip coating or die coating. Printing methods include relief printing such as flexographic printing, inkjet printing, intaglio printing such as direct gravure printing or offset gravure printing, lithographic printing such as offset printing, or stencil printing such as screen printing. A preferred printing method is inkjet printing.

The liquid crystal film exhibits birefringence of reverse wavelength dispersibility.

Reverse wavelength dispersibility of a material may be assessed via the Re₄₅₀ value, indicating the retardation of the material at a wavelength of 450 nm, the Re₅₅₀ value, indicating the retardation of the material at a wavelength of 550 nm, and the Re₆₅₀ value, indicating the retardation of the material at a wavelength of 650 nm. In a material having birefringence of reverse wavelength dispersion, the value of Re₄₅₀/Re₅₅₀ is below 1.0 and the value of Re₆₅₀/Re₅₅₀ is above 1.0, meaning that the magnitude of the birefringence (Δn) increases with increasing wavelength λ.

The present invention moreover provides the use of the liquid crystal film according to the invention in the manufacture of an optical device or an electro-optical device, such as an optical compensator for viewing angle enhancement of liquid crystal displays, or an achromatic retarder for display application, including for OLED anti-reflection.

The invention will be described in more detail by the accompanying drawings and the subsequent examples.

### EXAMPLES

The following abbreviations are used:
BDDV 1,4-divinyloxybutane
BHT 2,6-di-tert-butyl-4-methylphenol
CE1 [(E)-1-(4-phenylsulfanylbenzoyl)heptylideneamino]benzoate
CE2 [(Z)-1-[9-ethyl-6-(2-methylbenzoyl)carbazol-3-yl]ethylideneamino]acetate
CE3 [(Z)-[1-[4-[4-(benzofuran-2-carbonyl)phenyl]sulfanylphenyl]-4-methyl-pentylidene]amino]acetate
DPCA Kayarad DPCA-20, a dipentaerythritol polyfunctional acrylate wherein the dipentaerythritol is modified with caprolactone
FPC-1 [3-methyl-4-[4-(6-prop-2-enoyloxyhexoxy)benzoyl]oxy-phenyl]4-(6-prop-2-enoyloxyhexoxy)benzoate
LPP linear photopolymerizable polymer
PH1 [4-[6-[(2)-2-acetoxyiminoheptanoyl]-9-(2-ethylhexyl) carbazole-3-carbonyl]phenyl] acetate
PH2 [4-[6-[(2)-2-acetoxyiminohexanoyl]-9-ethyl-carbazole-3-carbonyl]phenyl] hexanoate
PH3 [1-[9-(2-ethylhexyl)-6-(4-methoxycarbonyloxybenzoyl) carbazole-3-carbonyl]propylideneamino]acetate
PH4 [1-[9-ethyl-6-(4-propoxycarbonyloxybenzoyl) carbazole-3-carbonyl]pentylideneamino]acetate
PH5 [1-[6-(4-butoxycarbonyloxybenzoyl)-9-ethyl-carbazole-3-carbonyl]hexylideneamino]acetate
PH6 [1-[6-(4-ethoxycarbonyloxybenzoyl)-9-ethyl-carbazole-3-carbonyl]hexylideneamino]acetate
PTMP pentaerythritol tetrakis(3-mercaptopropionate)
RWD1 [2-[[1,3-benzothiazol-2-yl(hexyl)hydrazono]methyl]-4-(4-pentylcyclohexanecarbonyl)oxy-phenyl] 4-(6-prop-2-enoyloxyhexoxy)benzoate
RWD2 [3-[[1,3-benzothiazol-2-yl(hexyl)hydrazono]methyl]-4-(4-ethylcyclohexane-carbonyl)oxy-phenyl] 4-(6-prop-2-enoyloxyhexoxy)benzoate
RWD3 [3-[[1,3-benzothiazol-2-yl(hexyl)hydrazono]methyl]-4-[4-(6-prop-2-enoyloxyhexoxy)benzoyl]oxy-phenyl] 4-(6-prop-2-enoyloxyhexoxy)benzoate
RWD4 3-[[hexyl(quinoxalin-2-yl)hydrazono]methyl]-4-[4-(6-prop-2-enoyloxyhexoxy)benzoyl]oxy-phenyl] 4-(6-prop-2-enoyloxyhexoxy)benzoate
TAC cellulose triacetate

### Methods

### Alignment Quality

The alignment quality of the liquid crystal in the film was checked by placing the film between two crossed polarizers and adjusting to obtain dark state. The alignment quality is defined to be very good if the dark state shows no defects and the liquid crystal is well oriented. The alignment quality is defined to be good if the dark state has light leakage because of the liquid crystal's inhomogeneous orientation. The alignment quality is defined to be medium if the dark state has light leakage with some areas with crystallisation. The alignment quality is defined to be bad if the liquid crystal is not oriented with absence of dark state.

### Thermal Reliability

The films from composition 1 to composition X described below were laminated onto a pressure sensitive adhesive PSA OC8171 (3M) coated onto a glass substrate. The TAC substrate was then peeled off. The total stack that was then Glass/PSA/polymer film was subjected to thermal reliability experiment. The film was stressed at 85° C. up to 200 h. An Axoscan ellipsometer is used to determine the retardation before and after thermal stress. The % reliability against thermal treatment is quantified by the difference in retardation, Δ Re, at 550 nm before and after heating at 85° C. divided by the retardation before stress.

The results of the thermal reliability evaluation are summarized in the table 1.

### Preparation of an Alignment Layer

A TAC 80 μm (FT TD80ULM form Fujifilm) substrate was spin-coated with a photoalignment composition (3% solid content of LPP polymer in cyclopentanone as described in WO 2012/085048). The coated substrate was dried at 80° C. for 30 s. The resulting thickness of the polymer layer was about 100 nm. Subsequently, the polymer layer was exposed to collimated and linearly polarized UV (LPUV) light (280-320 nm) at 250 mJ/cm². The plane of polarization was 0° with regard to a reference edge on the substrate.

### Preparation of the Liquid Crystal Films

The polymerizable liquid crystal compounds used in the polymerizable liquid crystal compositions are shown below.

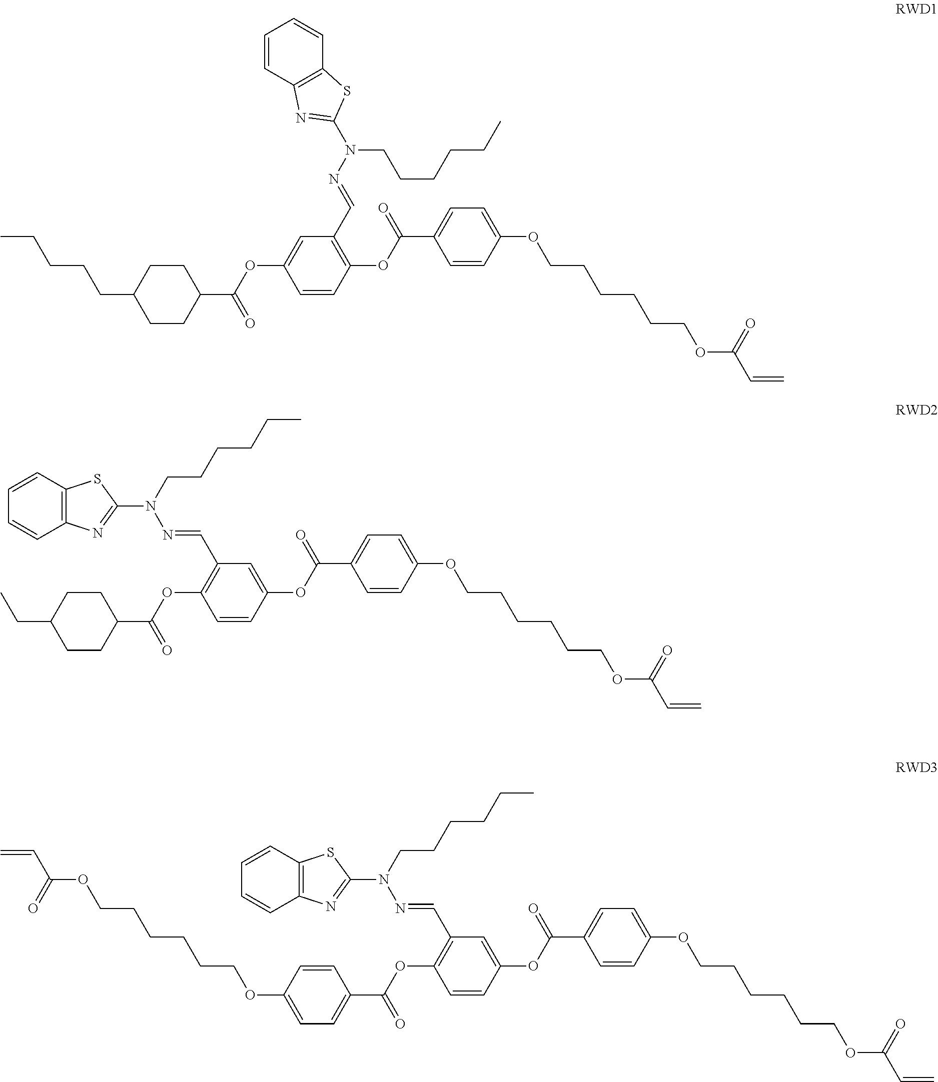

RWD1 and RWD2 were obtained according to the procedure described in WO 2021/037774 A1. RWD3 was obtained according to the according to the procedure described in US 2014/0142266 A1.

The photoinitiators used in the polymerizable liquid crystal compositions are shown below.

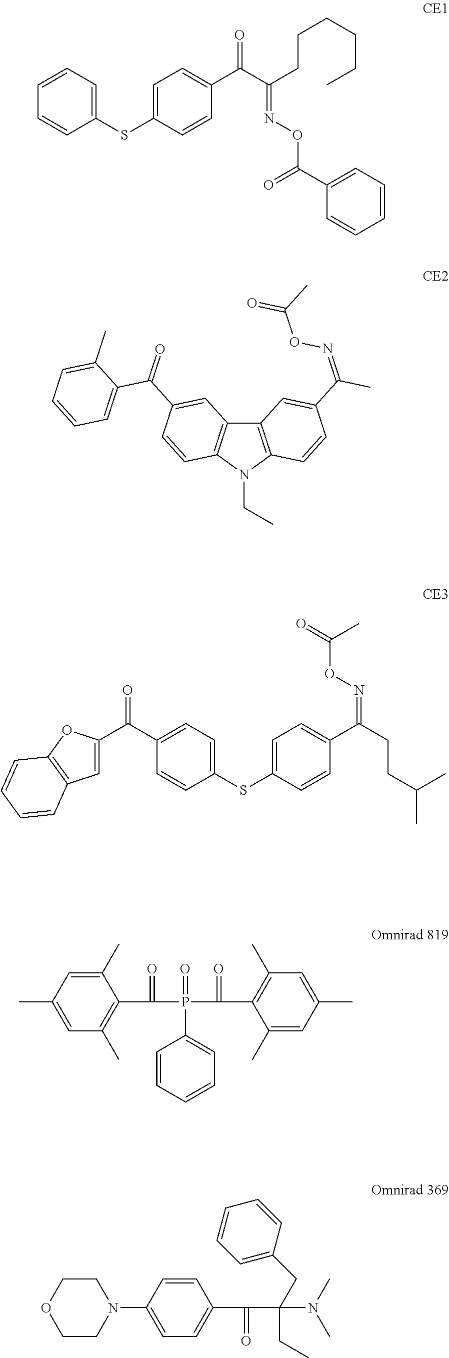

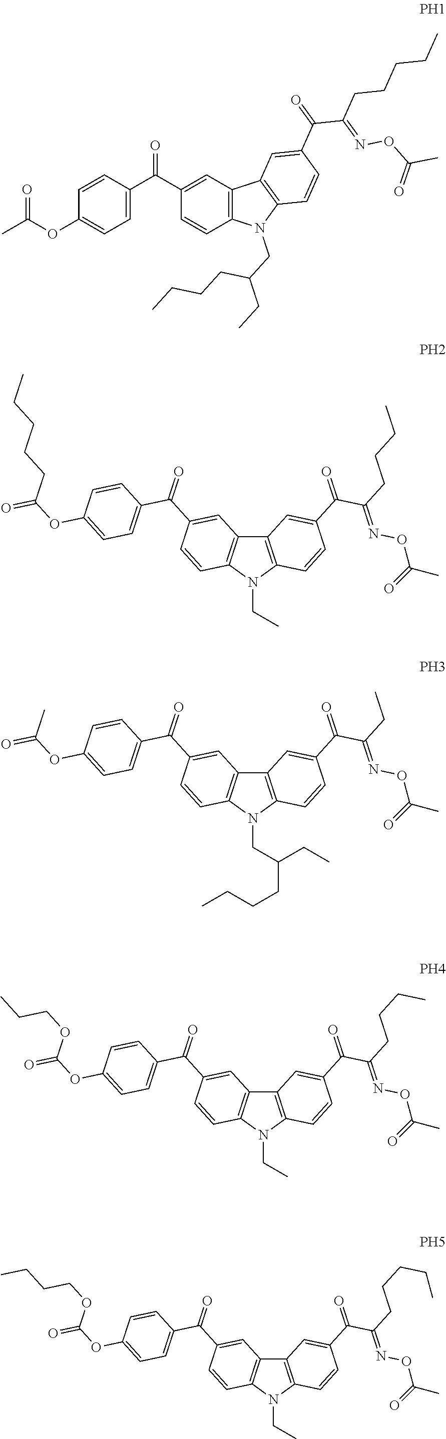

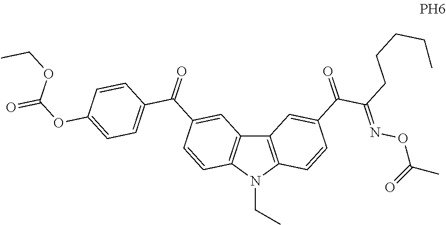 [SMILES: CCCCC/C(=N\OC(C)=O)C(=O)c1ccc2c(c1)c1cc(C(=O)c3ccc(OC(=O)OCC)cc3)ccc1n2CC]

### Example 1

A 35.0 wt.-% solution was prepared by mixing 15.050 wt.-% of RWD1, 12.443 wt.-% of RWD2, 0.0175 wt.-% of BHT (obtained from Sigma-Aldrich), 0.7 wt.-% of BDDV (obtained from BASF), 3.92 wt.-% of FPC-1 (obtained from Synthon Chemicals), 2.8 wt.-% of PH1 (obtained from BASF), and 0.070 wt.-% of Tego® Flow 300 (obtained from Evonik) in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 68° C. for 5 min in an oven. Photo-polymerization was carried out at 40 and 50° C., respectively, via irradiation with UV light under a nitrogen atmosphere using a high-pressure mercury lamp for approximately 2 min (total UV amount: 2.3 J).

### Example 2

A film was prepared as in example 1, with the difference that PH1 was replaced with PH2. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 3

A film was prepared as in example 1, with the difference that PH1 was replaced with PH3. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 4

A film was prepared as in example 1, with the difference that PH1 was replaced with PH4. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 5

A film was prepared as in example 1, with the difference that PH1 was replaced with PH5. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 6

A film was prepared as in example 1, with the difference that PH1 was replaced with PH6. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 7

A 35.0 wt.-% solution was prepared by mixing 15.050 wt.-% of RWD1, 12.443 wt.-% of RWD2, 0.0175 wt.-% of BHT, 0.7 wt.-% of BDDV, 3.92 wt.-% of FPC-1, 2.8 wt.-% of CE4 (obtained from BASF), 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 71° C. for 5 min in an oven. The sample was cooled down to room temperature. Photo-polymerization was carried out at 40 and 50° C., respectively, via irradiation with UV light under a nitrogen atmosphere using a high-pressure mercury lamp for approximately 2 min (total UV amount: 2.3 J).

### Example 8

A 35.0 wt.-% solution was prepared by mixing 15.050 wt.-% of RWD1, 12.443 wt.-% of RWD2, 0.0175 wt.-% of BHT, 0.7 wt.-% of BDDV, 3.92 wt.-% of FPC-1, 2.8 wt.-% of CE2 (obtained from BASF), 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 61° C. for 5 min in an oven. The sample was cooled down to room temperature. Photo-polymerization was carried out at 40 and 50° C., respectively via irradiation with UV light under a nitrogen atmosphere using a high-pressure mercury lamp for approximately 2 min (total UV amount: 2.3 J).

### Example 9

A 35.0 wt.-% solution was prepared by mixing 15.050 wt.-% of RWD1, 12.443 wt.-% of RWD2, 0.0175 wt.-% of BHT, 0.7 wt.-% of BDDV, 3.92 wt.-% of FPC-1, 2.8 wt.-% of CE1 (obtained from BASF), 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 63° C. for 5 min in an oven. The sample was cooled down to room temperature. Photo-polymerization was carried out at 40 and 50° C., respectively via irradiation with UV light under a nitrogen atmosphere using a high-pressure mercury lamp for approximately 2 min (total UV amount: 2.3 J).

### Example 10

A 35.0 wt.-% solution was prepared by mixing 15.050 wt.-% of RWD1, 12.443 wt.-% of RWD2, 0.0175 wt.-% of BHT, 0.7 wt.-% of BDDV, 3.92 wt.-% of FPC-1, 2.8 wt.-% of Omnirad® 819 (obtained from IGM Resins), 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 63° C. for 5 min in an oven. The sample was cooled down to room temperature. Photo-polymerization was carried out at 40 and 50° C., respectively via irradiation with UV light under a nitrogen atmosphere using a high-pressure mercury lamp for approximately 2 min (total UV amount: 2.3 J).

### Example 11

A 35.0 wt.-% solution was prepared by mixing 15.050 wt.-% of RWD1, 12.443 wt.-% of RWD2, 0.0175 wt.-% of BHT, 0.7 wt.-% of BDDV, 3.92 wt.-% of FPC-1, 2.8 wt.-% of Omnirad® 369 (obtained from IGM Resins), 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 56° C. for 5 min in an oven. The sample was cooled down to room temperature. Photo-polymerization was carried out at 40 and 50° C., respectively via irradiation with UV light under a nitrogen atmosphere using a high-pressure mercury lamp for approximately 2 min (total UV amount: 2.3 J).

### Example 12

A 35.0 wt.-% solution was prepared by mixing 15.4 wt.-% of RWD1, 13.493 wt.-% of RWD2, 0.0175 wt.-% of BHT, 0.7 wt.-% of BDDV, 3.92 wt.-% of FPC-1, 1.4 wt.-% of PH1, 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 77° C. for 5 min in an oven. The sample was cooled down to room temperature and then photo-polymerized at 50° C. by irradiation with UV light under a nitrogen atmosphere using a high-pressure mercury lamp for approximately 2 min (total UV amount: 2.3 J).

### Example 13

A film was prepared as in example 12, with the difference that PH1 was replaced with CE4. This film was annealed at 81° C. for 5 min in an oven and then photo-polymerized at 50° C. by irradiation with UV light under a nitrogen atmosphere using a high-pressure mercury lamp for approximately 2 min (total UV amount: 2.3 J).

### Example 14

A film was prepared as in example 12, with the difference that PH1 was replaced with CE2. This film was annealed at 74° C. for 5 min in an oven and then photo-polymerized at 50° C. by irradiation with UV light under a nitrogen atmosphere using a high-pressure mercury lamp for approximately 2 min (total UV amount: 2.3 J).

### Example 15

A film was prepared as in example 12, with the difference that PH1 was replaced with CE1. This film was annealed at 75° C. for 5 min in an oven and then photo-polymerized at 50° C. by irradiation with UV light under a nitrogen atmosphere using a high-pressure mercury lamp for approximately 2 min (total UV amount: 2.3 J).

### Example 16

A 35.0 wt.-% solution was prepared by mixing 15.75 wt.-% of RWD1, 11.74 wt.-% of RWD2, 0.0175 wt.-% of BHT, 0.7 wt.-% of DPCA (obtained from Nikka Fine), 3.92 wt.-% of FPC-1, 2.8 wt.-% of PH1, 0.070 wt.-% of Tego® Flow 300 in cyclohexanone/toluene 40/60. The solution was then stirred thoroughly until the solid was completely dissolved at 40° C. The solution was stirred thoroughly at 40° C. until the solid was completely dissolved. The solution was spin coated at 800 rpm onto the alignment layer of the substrate obtained as described above to obtain a film. This film was annealed at 67° C. for 5 min in an oven. The sample was cooled down to room temperature and then photo-polymerized at 50° C. by irradiation with UV light under a nitrogen atmosphere using a high-pressure mercury lamp for approximately 2 min (total UV amount: 2.3 J).

### Example 17

A film was prepared as in example 16, with the difference that PH1 was replaced with Ominrad® 819. This film was annealed at 60° C. for 5 min in an oven and then photo-polymerized at 50° C. by irradiation with UV light under a nitrogen atmosphere using a high-pressure mercury lamp for approximately 2 min (total UV amount: 2.3 J).

### Example 18

A film was prepared as in example 16, with the difference that in the example DPCA was replaced with PTMP (obtained from Sigma-Aldrich). This film was annealed at 65° C. for 5 min in an oven and then photo-polymerized at 50° C. by irradiation with UV light under a nitrogen atmosphere using a high-pressure mercury lamp for approximately 2 min (total UV amount: 2.3 J).

### Example 19

A film was prepared as in example 16, with the difference that PH1 was replaced with Omnirad 819 and DPCA was replaced with PTMP. This film was annealed at 60° C. for 5 min in an oven and then photo-polymerized at 50° C. by irradiation with UV light under a nitrogen atmosphere using a high-pressure mercury lamp for approximately 2 min (total UV amount: 2.3 J).

### Example 20

A film was prepared as in example 16, with the difference that no DPCA was added. This film was annealed at 69° C. for 5 min in an oven and then photo-polymerized at 50° C. by irradiation with UV light under a nitrogen atmosphere using a high-pressure mercury lamp for approximately 2 min (total UV amount: 2.3 J).

### Example 21

A film was prepared as in example 16, with the difference that PH1 was replaced with Omnirad 819 and no DPCA was added. This film was annealed at 63° C. for 5 min in an oven and then photo-polymerized at 50° C. by irradiation with UV light under a nitrogen atmosphere using a high-pressure mercury lamp for approximately 2 min (total UV amount: 2.3 J).

### Example 22

A 35.0 wt.-% solution was prepared by mixing 31.41 wt.-% of RWD3, 0.0175 wt.-% of inhibitor BHT, 0.7 wt.-% of BDDV, 2.8 wt.-% of PH1, 0.070 wt.-% of Tego® Flow 300 in cyclohexanone/toluene 40/60. The solution was stirred thoroughly at 40° C. until the solid was completely dissolved. The solution was spin coated at 800 rpm onto the alignment layer of the substrate obtained as described above to obtain a film. This film was annealed at 61° C. for 5 min in an oven. The sample was cooled down to room temperature and then photo-polymerized at 50° C. by irradiation with UV light under a nitrogen atmosphere using a high-pressure mercury lamp for approximately 2 min (total UV amount: 2.3 J).

TABLE 1
Thermal Reliability Evaluation

| | | | | Temperature | | % |
|---|---|---|---|---|---|---|
| | | | | during | | Reliability |
| | | | | UV | | at 550 |
| | | Photoinitiator | | exposure | | nm |
| Example | RWD LCP | ** | Crosslinker | [° C.] | Re₄₅₀/Re₅₅₀ | (85° C.) |
| 1 | RWD1/RWD2 | PH1, 2.8 wt.-% | BDDV | 40 | 0.926 | 11.3% |
| 2 | RWD1/RWD2 | PH2, 2.8 wt.-% | BDDV | 50 | 0.947 | 11.4% |
| 3 | RWD1/RWD2 | PH3, 2.8 wt.-% | BDDV | 50 | 0.947 | 9.5% |
| 4 | RWD1/RWD2 | PH4, 2.8 wt.-% | BDDV | 50 | 0.957 | 7.3% |
| 5 | RWD1/RWD2 | PH5, 2.8 wt.-% | BDDV | 50 | 0.945 | 10.1% |
| 6 | RWD1/RWD2 | PH6, 2.8 wt.-% | BDDV | 50 | 0.943 | 11.2% |
| 7 * | RWD1/RWD2 | CE4, 2.8 wt.-% | BDDV | 40 | 0.936 | 19.5% |
| 8 * | RWD1/RWD2 | CE2, 2.8 wt.-% | BDDV | 40 | 0.929 | 22.9% |
| 9 * | RWD1/RWD2 | CE1, 2.8 wt.-% | BDDV | 40 | 0.895 | 21.6% |
| 10 * | RWD1/RWD2 | Omnirad | BDDV | 40 | 0.880 | 23.5% |
| | | 819, 2.8 wt.-% | | | | |
| 11 * | RWD1/RWD2 | Omnirad | BDDV | 40 | 0.899 | 32.5% |
| | | 369, 2.8 wt.-% | | | | |
| 1 | RWD1/RWD2 | PH1, 2.8 wt.-% | BDDV | 50 | 0.926 | 7.1% |
| 7 * | RWD1/RWD2 | CE4, 2.8 wt.-% | BDDV | 50 | 0.936 | 14.1% |
| 8 * | RWD1/RWD2 | CE2, 2.8 wt.-% | BDDV | 50 | 0.929 | 14.4% |
| 9 * | RWD1/RWD2 | CE1, 2.8 wt.-% | BDDV | 50 | 0.895 | 15.6% |
| 10 * | RWD1/RWD2 | Omnirad | BDDV | 50 | 0.880 | 12.0% |
| | | 819, 2.8 wt.-% | | | | |
| 11 * | RWD1/RWD2 | Omnirad | BDDV | 50 | 0.899 | 28.6% |
| | | 369, 2.8 wt.-% | | | | |
| 12 | RWD1/RWD2 | PH1, 1.4 wt.-% | BDDV | 50 | 0.892 | 13.4% |
| 13 * | RWD1/RWD2 | CE4, 1.4 wt.-% | BDDV | 50 | 0.906 | 17.0% |
| 14 * | RWD1/RWD2 | CE2, 1.4 wt.-% | BDDV | 50 | 0.895 | 22.4% |
| 15 * | RWD1/RWD2 | CE1, 1.4 wt.-% | BDDV | 50 | 0.874 | 28.3% |
| 16 | RWD1/RWD2 | PH1, 2.8 wt.-% | DPCA | 50 | 0.941 | 5.2% |
| 17 * | RWD1/RWD2 | Omnirad | DPCA | 50 | 0.902 | 12.2% |
| | | 819, 2.8 wt.-% | | | | |
| 18 | RWD1/RWD2 | PH1, 2.8 wt.-% | PTMP | 50 | 0.939 | 4.2% |
| 19 * | RWD1/RWD2 | Omnirad, 2.8 | PTMP | 50 | 0.903 | 12.6% |
| | | wt.-% | | | | |
| 20 | RWD1/RWD2 | PH1, 2.8 wt.-% | — | 50 | 0.933 | 5.2% |
| 21 * | RWD1/RWD2 | Omnirad, 2.8 | — | 50 | 0.900 | 10.5% |
| | | wt.-% | | | | |
| 22 | RWD3 | PH1, 2.8 wt.-% | BDDV | 50 | 0.976 | 5.0% |

* comparative example
** amounts provided relative to the total weight of the polymerizable liquid crystal composition

The films of examples composition 1 to 22 all exhibited a very good alignment quality. As the results shown in Table 1 demonstrate, reliability is improved for the examples in which an α-oxo oxime ester photoinitiator according to formula (I) was used.

1. A polymerizable liquid crystal composition comprising (i) a polymerizable liquid crystal compound capable of exhibiting birefringence of reverse wavelength dispersibility when the polymerizable liquid crystal compound is in an oriented state, and (ii) a polymerization initiator, which is represented by the following formula (I) 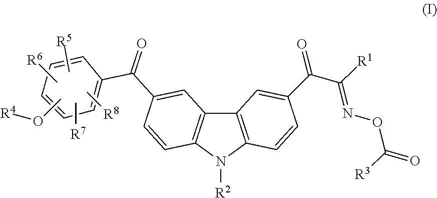
wherein
R¹ is hydrogen, C₁-C₂₀-alkyl, C₁-C₆-alkyl-C₃-C₆-cycloalkyl, C₃-C₂₀-cycloalkyl, or C₂-C₁₂-alkenyl, wherein C₃-C₂₀-cycloalkyl or C₂-C₁₂-alkenyl is uninterrupted or interrupted by one or more O, S, CO, NR¹⁰ or COOR⁴; or
R¹ is C₁-C₂₀alkyl which is unsubstituted or substituted by one or more halogen, OR⁴, SR⁹, NR¹⁰R¹¹, COOR⁴ CONR¹⁰R¹¹, CN, PO(OR^{3a})₂, S(O)ₘ—R^{3a}, 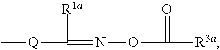
C₃-C₈cycloalkyl which is uninterrupted or interrupted by one or more O, S, CO or NR¹⁰; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR⁴, SR⁹, NR¹⁰R¹¹, PO(OR^{3a})₂ or S(O)ₘ—R^{3a}, or
R¹ is C₂-C₂₀alkyl which is interrupted by one or more O, CO, S, C(O)O, OC(O), SO, SO₂, phenylene, naphthylene or NR¹⁰, wherein the interrupted C₂-C₂₀alkyl is unsubstituted or substituted by one or more halogen, C₃-C₈cycloalkyl, OH, SH, OR⁴, SR⁹, COOR⁴, O(CO)—R^{3a}, CONR¹⁰R¹¹, NR¹⁰R¹¹, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR⁴, SR⁹ or NR¹⁰R¹¹; or
R¹ is C₆-C₂₀aryl or C₃-C₂₀heteroaryl each of which is unsubstituted or substituted by one or more C₁-C₂₀alkyl, phenyl, halogen, C₁-C₄haloalkyl, CN, NO₂, OR⁴, SR⁹, NR¹⁰R¹¹, COOR⁴, (CO)—R^{3a}, (CO)NR¹⁰R¹¹, PO(OR^{3a})₂, S(O)ₘ—R^{3a} or group 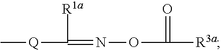
or by one or more C₂-C₂₀alkyl which is interrupted by one or more O, S, or NR¹⁰; or by one or more C₁-C₂₀alkyl which is unsubstituted or substituted by one or more halogen, COOR⁴, CONR¹⁰R¹¹, phenyl, C₃-C₈cycloalkyl, C₃-C₂₀heteroaryl, C₆-C₂₀aryloxycarbonyl, C₃-C₂₀heteroaryloxycarbonyl, OR⁴, SR⁹ or NR¹⁰R¹¹; or by one or more phenyl, naphthyl, benzoyl or naphthoyl, each of which is unsubstituted or substituted by OR⁴, SR⁹ or NR¹⁰R¹¹; or
R¹ is C₂-C₂₀alkanoyl or benzoyl which is unsubstituted or substituted by one or more C₁-C₆alkyl, phenyl, OR⁴, SR⁹ or NR¹⁰R¹¹; or
R¹ is C₂-C₁₂alkoxycarbonyl optionally interrupted by one or more —O— and/or optionally substituted by one or more hydroxyl groups; or
R¹ is phenoxycarbonyl which is unsubstituted or substituted by C₁-C₆alkyl, halogen, phenyl, OR⁴, SR⁹ or NR¹⁰R¹¹; or
R¹ is CN, (CO)—R^{3a}, COOR⁴, CONR¹⁰R¹¹, NO₂, PO(OR^{3a})₂ or S(O)ₘ—R^{3a};
R^{1a} is hydrogen, C₁-C₂₀alkyl, CN, (CO)—R^{3a}, COOR^{4a}, CONR^{10a}R^{11a}, NO₂, PO(OR^{3a})₂ or S(O)ₘ—R^{3a}, or
R^{1a} is C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}, or
R^{1a} is C₁-C₂₀alkyl interrupted by one or more O, S, NR^{10a}, CO, SO or SO₂, which is unsubstituted or substituted by C₃-C₈cycloalkyl, OH, SH, O(CO)R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{1a} is C₂-C₁₂alkenyl or C₃-C₂₀cycloalkyl, each of which is uninterrupted or interrupted by one or more O, S, CO, NR^{10a} or COOR^{4a}, or
R^{1a} is C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a} CONR^{10a}R^{11a}, PO(OR^{3a})₂ or S(O)ₘ—R^{3a}, or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}, or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a};
R² is hydrogen, C₁-C₂₀-alkyl or C₁-C₆-alkyl-C₃-C₆-cycloalkyl which is unsubstituted or substituted by one or more halogen, OR⁴, SR⁹, COOR⁴CONR¹⁰R¹¹, NR¹⁰R¹¹, PO(OR^{3a})₂, COR^{3a}, or
R² is C₂-C₂₀alkyl or C₁-C₆alkyl-C₃-C₆-cycloalkyl which is interrupted by one or more O, CO, S, C(O)O, OC(O), SO, SO₂, phenylene, naphthylene or NR¹⁰; wherein the interrupted C₂-C₂₀alkyl is unsubstituted or substituted by one or more halogen, OR⁴, SR⁹, COOR⁴, CONR¹⁰R¹¹, NR¹⁰R¹¹; or
R² is C₂-C₄hydroxyalkyl, C₂-C₁₀alkoxyalkyl, C₃-C₈alkenyl, C₃-C₈cycloalkyl, phenyl-C₁-C₃alkyl, C₂-C₈alkanoyl, C₃-C₁₂alkenoyl, benzoyl; or
R² is C₆-C₂₀aryl or C₃-C₂₀heteroaryl each of which is unsubstituted or substituted by one or more C₁-C₁₂alkyl, C₁-C₄haloalkyl, phenyl, halogen, CN, NO₂, OR⁴, SR⁹, NR¹⁰R¹¹, (CO)—R^{3a}, or by C₂-C₂₀alkyl which is interrupted by one or more O, S, or NR¹⁰, or each of which is substituted by one or more C₁-C₂₀alkyl which is unsubstituted or substituted by one or more halogen, COOR⁴, CONR¹⁰R¹¹, phenyl, C₃-C₈cycloalkyl, C₃-C₂₀heteroaryl, C₆-C₂₀aryloxycarbonyl, C₃-C₂₀heteroaryloxycarbonyl, OR⁴, SR⁹ or NR¹⁰R¹¹, or
R² is a group 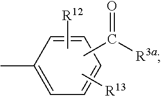
R³ is hydrogen or C₁-C₂₀-alkyl; or
R³ is C₁-C₂₀alkyl substituted by one or more halogen, OR⁴, SR⁹, NR¹⁰R¹¹, CN, COOR⁴, CONR¹⁰R¹¹, C₃-C₈cycloalkyl which is uninterrupted or interrupted by one or more O, S, CO or NR¹⁰; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR⁴, SR⁹ or NR¹⁰R¹¹; or
R³ is C₁-C₂₀alkyl interrupted by one or more O, S, NR¹⁰, CO, SO or SO₂, which is unsubstituted or substituted by C₃-C₈cycloalkyl, OH, SH, O(CO)—R^{3a}, COOR⁴, CONR¹⁰R¹¹C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR⁴, SR⁹ or NR¹⁰R¹¹, or
R³ is C₂-C₁₂alkenyl or C₃-C₂₀cycloalkyl, each of which is uninterrupted or interrupted by one or more O, S, CO, NR¹⁰ or COOR⁴; or
R³ is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR⁴, SR⁹, NR¹⁰R¹¹, COOR⁴, (CO)—R^{3a} or SO₂—R^{3a}, or
R³ is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R³ is C₁-C₂₀alkoxy, which is interrupted by one or more O, S, NR¹⁰, CO, SO or SO₂; or
R³ is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR⁴, SR⁹, NR¹⁰R¹¹, COOR⁴, (CO)—R^{3a} or SO₂—R^{3a}, R^{3a} is hydrogen or C₁-C₂₀-alkyl; or
R^{3a} is C₁-C₂₀alkyl substituted by one or more halogen, OR^{4a}, SR^{9a}, NR^{10a}R^{11a}, CN, COOR⁴a CONR^{10a}R^{11a}, C₃-C₈cycloalkyl which is uninterrupted or interrupted by one or more O, S, CO or NR^{10a}, or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR⁴a SR^{9a} or NR^{10a}R^{11a}, or
R^{3a} is C₁-C₂₀alkyl interrupted by one or more O, S, NR^{10a}, CO, SO or SO₂, which is unsubstituted or substituted by C₃-C₈cycloalkyl, OH, SH, O(CO)—(C₁-C₈alkyl), COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{3a} is C₂-C₁₂alkenyl or C₃-C₂₀cycloalkyl, each of which is uninterrupted or interrupted by one or more O, S, CO, NR^{10a} or COOR^{4a}; or
R^{3a} is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3a} is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R^{3a} is C₁-C₂₀alkoxy, which is interrupted by one or more O, S, NR^{10a}, CO, SO or SO₂; or
R^{3a} is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3a} is a group 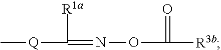
R^{3b} is hydrogen or C₁-C₂₀alkyl; or
R^{3b} is C₁-C₂₀alkyl substituted by one or more halogen, OR^{4a}, SR^{9a}, NR^{10a}R^{11a}, CN, COOR^{4a}, CONR^{10a}R^{11a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a} or NR^{10a}R^{11a}; or
R^{3b} is C₁-C₂₀alkyl interrupted by one or more O, S, NR^{10a}, CO, SO or SO₂, which is unsubstituted or substituted by C₃-C₈cycloalkyl, OH, SH, O(CO)—(C₁-C₈alkyl), COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R^{3b} is C₂-C₁₂alkenyl or C₃-C₂₀cycloalkyl, each of which is uninterrupted or interrupted by one or more O, S, CO, NR^{10a} or COOR^{4a}; or
R^{3b} is C₆-C₂₀aryl or C₃-C₂₀heteroaryl, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl); or
R^{3b} is C₁-C₂₀alkoxy, which is unsubstituted or substituted by one or more C₁-C₁₀alkyl, C₁-C₄haloalkyl, halogen, phenyl, C₁-C₂₀alkylphenyl or C₁-C₈alkoxyphenyl; or
R^{3b} is C₁-C₂₀alkoxy, which is interrupted by one or more O, S, NR^{10a}, CO, SO or SO₂; or
R^{3b} is C₆-C₂₀aryloxy or C₃-C₂₀heteroaryloxy, each of which is unsubstituted or substituted by one or more halogen, C₁-C₂₀alkyl, C₁-C₄haloalkyl, phenyl, C₁-C₂₀alkylphenyl, C₁-C₈alkoxyphenyl, CN, NO₂, OR^{4a}, SR^{9a}, NR^{10a}R^{11a}, COOR^{4a}, (CO)—(C₁-C₈alkyl) or SO₂—(C₁-C₄haloalkyl);
R⁴ is hydrogen, (CO)—R^{3a}, COOR^{4a}, CO NR^{10a}R^{11a}, S(O)ₘ—R^{3a} or PO(OR^{3a})₂; or
R⁴ is C₁-C₂₀alkyl, which is substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}; or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}; or
R⁴ is C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}, or
R⁴ is C₂-C₁₂alkenyl or C₃-C₂₀cycloalkyl, each of which is uninterrupted or interrupted by one or more O, S, CO, NR^{10a} or COOR^{4a}, or
R⁴ is C₆-C₂₀aryl, which is substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group 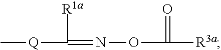
or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}, or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}, or
R⁴ is C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group 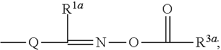
or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}, or by one or more C₂-C₂₀alkyl which is interrupted by one or more O, S or NR^{10a}, or by one or more phenyl, naphthyl, benzoyl or naphthoyl, each of which is unsubstituted or substituted by OR^{4a}, SR^{9a} or NR^{10a}R^{11a}, or
R⁴ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄haloalkyl, CN, phenyl, C₁-C₂₀alkylphenyl, C₁-C₈alkoxyphenyl, 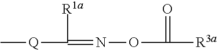
or C₃-C₂₀cycloalkyl which is uninterrupted or interrupted by one or more O, S, CO or NR^{10a},
R^{4a} is hydrogen, C₁-C₂₀-alkyl, (CO)O(C₁-C₈-alkyl) or CON(C₁-C₈-alkyl)₂; or
R^{4a} is C₁-C₂₀alkyl substituted by one or more halogen, OH, SH, CN, C₃-C₈alkenoxy, OCH₂CH₂CN, OCH₂CH₂ (CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{4a} is C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{4a} is C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₃alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈)₂, phenyl or benzoyl;
R^{4a} is C₂-C₁₂alkenyl, (CO)O(C₁-C₈alkenyl) or C₃-C₈cycloalkyl, each of which is uninterrupted or interrupted by one or more O, S, CO, N(C₁-C₈alkyl) or COO(C₁-C₈alkyl); or
R^{4a} is C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino;
R⁵, R⁶, R⁷ and R⁸ independently of each other are hydrogen, C₁-C₂₀-alkyl, C₆-C₂₀-aryl, C₁-C₂₀-alkoxy, C₆-C₂₀-aryl C₁-C₂₀-alkyl, hydroxyl-C₁-C₂₀-alkyl, hydroxyl-C₁-C₂₀-alkoxy-C₁-C₂₀-alkyl, C₃-C₁₀-cycloalkyl, amino, CN, NO₂, hydroxy, 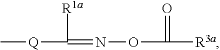
(CO)—R^{3a} OR^{4a} or COOR⁴;
R⁹ is hydrogen or C₁-C₂₀alkyl; or
R⁹ is C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}, or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a}, PO(OR^{3a})₂ or S(O)ₘ—R^{3a}, or
R⁹ is C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR⁴a CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}; or
R⁹ is C₂-C₁₂alkenyl or C₃-C₂₀cycloalkyl, each of which is uninterrupted or interrupted by one or more O, S, CO, NR^{10a} or COOR^{4a}, or
R⁹ is C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a}, CONR^{10a}R^{11a}, PO(OR^{3a})₂, S(O)ₘ—R^{3a} or group 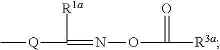
or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}, or by one or more C₂-C₂₀alkyl which is interrupted by one or more O, S or NR^{10a}; or by one or more phenyl, naphthyl, benzoyl or naphthoyl, each of which is unsubstituted or substituted by OR^{4a}, SR^{9a} or NR^{10a}R^{11a}, or
R⁹ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄haloalkyl, CN, phenyl, C₁-C₂₀alkylphenyl, C₁-C₈alkoxyphenyl, 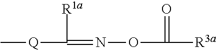
or C₃-C₂₀cycloalkyl which is uninterrupted or interrupted by one or more O, S, CO or NR^{10a};
R^{9a} is hydrogen or C₁-C₂₀alkyl; or
R^{9a} is C₁-C₂₀alkyl substituted by one or more halogen, OH, SH, CN, C₃-C₈alkenoxy, OCH₂CH₂CN, OCH₂CH₂ (CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{9a} is C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{9a} is C₂-C₁₂alkenyl or C₃-C₈cycloalkyl, each of which is uninterrupted or interrupted by one or more O, S, CO, N(C₁-C₈alkyl) or COO(C₁-C₈alkyl); or
R^{9a} is C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₃alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈)₂, phenyl or benzoyl; or
R^{9a} is C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino;
R¹⁰ and R¹¹ independently of each other are hydrogen, C₁-C₂₀-alkyl, S(O)ₘ—R^{3a}, O(CO)—R^{3a} (CO)—R^{3a} or CONR^{10a}R^{11a}, or
R¹⁰ and R¹¹ independently of each other are C₁-C₂₀alkyl substituted by one or more halogen, OR^{4a}, SR^{9a}, NR^{10a}R^{11a}, CN, COOR^{4a}, CONR^{10a}R^{11a}, PO(OR^{3a})₂, S(O)ₘ—R^{3a}, C₃-C₈cycloalkyl which is uninterrupted or interrupted by one or more O, S, CO or NR^{10a}, or by one or more C₆-C₂₀aryl, C₃-C₂₀heteroaryl, C₆-C₂₀aroyl or C₃-C₂₀heteroarylcarbonyl, each of which is unsubstituted or substituted by one or more halogen, phenyl, C₁-C₂₀alkylphenyl, C₁-C₈alkoxyphenyl, C₁-C₄haloalkyl, CN, NO₂, OR^{4a}, SR^{9a}, NR^{10a}R^{11a} PO(OR^{3a})₂ or S(O)ₘ—R^{3a}; or
R¹⁰ and R¹¹ independently of each other are C₁-C₂₀alkyl interrupted by one or more O, S, NR^{10a}, CO, SO or SO₂, which is unsubstituted or substituted by C₃-C₈cycloalkyl, OH, SH, O(CO)—R^{3a}, COOR^{4a}, CONR^{10a}R^{11a}, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, OR^{4a}, SR^{9a} or NR^{10a}R^{11a}, or
R¹⁰ and R¹¹ independently of each other are C₂-C₁₂alkenyl or C₃-C₂₀cycloalkyl, each of which is uninterrupted or interrupted by one or more O, S, CO, NR^{10a} or COOR^{4a}, or
R¹⁰ and R¹¹ independently of each other are C₆-C₂₀aryl or C₃-C₂₀heteroaryl, each of which is unsubstituted or substituted by one or more halogen, CN, NO₂, OR^{4a}, SR^{9a}, NR^{10a}R^{11a}, COOR^{4a}, (CO)—R^{3a} CONR^{10a}R^{11a}, PO(OR^{3a})₂, S(O)ₘ—R^{3a} or group 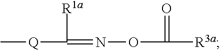
or by one or more C₁-C₂₀alkyl which is unsubstituted or substituted by one or more halogen, COOR^{4a}, CONR^{10a}R^{11a}, phenyl, C₃-C₈cycloalkyl, C₃-C₂₀heteroaryl, OR^{4a}, SR^{9a} or NR^{10a}R^{11a}, or by one or more C₂-C₂₀alkyl which is interrupted by one or more O, S or NR^{10a}, or by one or more phenyl, naphthyl, benzoyl or naphthoyl, each of which is unsubstituted or substituted by OR^{4a}, SR^{9a} or NR^{10a}R^{11a}, or
R¹⁰ and R¹¹ independently of each other are C₁-C₂₀alkoxy, which is unsubstituted or substituted by one or more halogen, phenyl, C₁-C₈alkylphenyl or C₁-C₈alkoxyphenyl; or
R¹⁰ and R¹¹ independently of each other are C₁-C₂₀alkoxy, which is interrupted by one or more O, S, NR^{10a}, CO, SO or SO₂; or
R¹⁰ and R¹¹ independently of each other are C₆-C₂₀aryloxy or C₃-C₂₀heteroaryloxy, each of which is unsubstituted or substituted by one or more halogen, C₁-C₈alkyl, C₁-C₄haloalkyl, phenyl, C₁-C₈alkylphenyl, C₁-C₈alkoxyphenyl, CN, NO₂, OR^{4a}, SR^{9a}, NR^{10a}R^{11a}, COOR^{4a}, (CO)—R^{3a} or SO₂—R^{3a}, or
R¹⁰ together with one of the carbon atom of R¹ forms a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄-haloalkyl, CN, phenyl, C₁-C₂₀alkylphenyl, C₁-C₈alkoxyphenyl, 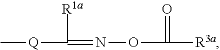
or C₃-C₂₀cycloalkyl which is uninterrupted or interrupted by one or more O, S, CO or NR^{10a}, or
R¹⁰ and R¹¹ together with the N-atom to which they are attached form a 5- or 6-membered saturated or unsaturated ring which is uninterrupted or interrupted by O, S or NR^{10a}, and which 5- or 6-membered saturated or unsaturated ring is unsubstituted or substituted by one or more C₁-C₂₀alkyl, OR^{4a}, SR^{9a}, NR^{10a}R^{11a}, (CO)—R^{3a}, NO₂, halogen, C₁-C₄-haloalkyl, CN, phenyl, 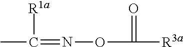
or C₃-C₂₀cycloalkyl which is uninterrupted or interrupted by one or more O, S, CO or NR^{10a};
R^{10a} and R^{11a} independently of each other are hydrogen, C₁-C₂₀alkyl, S(O)ₘ—(C₁-C₈alkyl), O(CO)(C₁-C₈alkyl), (CO)(C₁-C₈alkyl), (CO)O(C₁-C₈alkyl) or CON(C₁-C₈alkyl)₂; or
R^{10a} and R^{11a} independently of each other are C₁-C₂₀alkyl substituted by one or more halogen, OH, SH, CN, C₃-C₈alkenoxy, OCH₂CH₂CN, OCH₂CH₂ (CO)O(C₁-C₈alkyl), O(CO)—(C₁-C₈alkyl), O(CO)—(C₂-C₄)alkenyl, O(CO)-phenyl, (CO)OH, (CO)O(C₁-C₈alkyl), C₃-C₈cycloalkyl, SO₂—(C₁-C₄haloalkyl), O(C₁-C₄haloalkyl), phenyl, C₁-C₈alkylphenyl, C₁-C₈alkoxyphenyl or C₃-C₈cycloalkyl which is interrupted by one or more O; or
R^{10a} and R^{11a} independently of each other are C₂-C₂₀alkyl interrupted by one or more O, S, N(C₁-C₈alkyl), CO, SO or SO₂, which is unsubstituted or substituted by C₃-C₈cycloalkyl, OH, SH, O(CO)(C₁-C₈alkyl), (CO)O(C₁-C₈alkyl), (CO)N(C₁-C₈alkyl)₂, C₆-C₂₀aryl, C₃-C₂₀heteroaryl, C₆-C₂₀aroyl or C₃-C₂₀heteroarylcarbonyl, wherein C₆-C₂₀aryl, C₃-C₂₀heteroaryl, C₆-C₂₀aroyl or C₃-C₂₀heteroarylcarbonyl is unsubstituted or substituted by one or more halogen, C₁-C₈alkyl, C₁-C₈alkoxy, C₁-C₈alkylsulfanyl or N(C₁-C₈alkyl)₂; or
R^{10a} and R^{11a} independently of each other are C₂-C₁₂alkenyl or C₃-C₈cycloalkyl, each of which is uninterrupted or interrupted by one or more O, S, CO, N(C₁-C₈alkyl) or COO(C₁-C₈alkyl); or
R^{10a} and R^{11a} independently of each other are C₆-C₂₀aryl, C₃-C₂₀heteroaryl, C₆-C₂₀aroyl or C₃-C₂₀heteroarylcarbonyl, each of which is unsubstituted or substituted by one or more halogen, CN, NO₂, OH, C₁-C₈alkyl, C₁-C₄haloalkyl, C₁-C₈alkoxy, phenyl-C₁-C₃alkyloxy, phenoxy, C₁-C₈alkylsulfanyl, phenylsulfanyl, N(C₁-C₈alkyl)₂, diphenylamino, (CO)O(C₁-C₈alkyl), (CO)—C₁-C₈alkyl or (CO)N(C₁-C₈alkyl)₂, phenyl or benzoyl; or
R^{10a} and R^{11a} independently of each other are C₁-C₂₀alkanoyl, C₃-C₁₂alkenoyl, each of which is unsubstituted or substituted by one or more halogen, phenyl, C₁-C₈alkylphenyl, C₁-C₈alkoxyphenyl, OH, C₁-C₈alkoxy, phenoxy, C₁-C₈alkylsulfanyl, phenylsulfanyl, N(C₁-C₈alkyl)₂ or diphenylamino; or
R^{10a} and R^{11a} independently of each other are C₁-C₂₀alkoxy, which is unsubstituted or substituted by one or more halogen, phenyl, C₁-C₈alkylphenyl or C₁-C₈alkoxyphenyl; or
R^{10a} and R^{11a} independently of each other are C₁-C₂₀alkoxy, which is interrupted by one or more O, S, N(C₁-C₈alkyl), CO, SO or SO₂; or
R^{10a} and R^{11a} independently of each other are C₆-C₂₀aryloxy or C₃-C₂₀heteroaryloxy, each of which is unsubstituted or substituted by one or more halogen, C₁-C₈alkyl, C₁-C₄haloalkyl, phenyl, C₁-C₈alkylphenyl, C₁-C₈alkoxyphenyl, CN, NO₂, C₁-C₈alkoxy, C₁-C₈alkylsulfanyl, N(C₁-C₈alkyl)₂, CO(OC₁-C₈alkyl), (CO)—(C₁-C₈alkyl) or SO₂—(C₁-C₈alkyl); or
R^{10a} and R^{11a} together with the N-atom to which they are attached form a 5- or 6-membered saturated or unsaturated ring which is uninterrupted or interrupted by O, S or N(C₁-C₈alkyl), and which 5- or 6-membered saturated or unsaturated ring is unsubstituted or substituted by one or more C₁-C₈alkyl, C₁-C₈alkoxy, C₁-C₈alkylsulfanyl, N(C₁-C₈alkyl)₂, NO₂, halogen, C₁-C₄haloalkyl, CN, phenyl or C₃-C₂₀cycloalkyl which is uninterrupted or interrupted by one or more O, S, CO or N(C₁-C₈alkyl);
R¹² and R¹³ independently of each other are hydrogen, C₁-C₁₂alkyl optionally substituted by one or more halogen, phenyl, CN, —OH, —SH, C₁-C₄alkoxy, (CO)OH or (CO)O(C₁-C₄alkyl); or
R¹² and R¹³ are phenyl optionally substituted by one or more C₁-C₆alkyl, halogen, CN, OR⁴, SR⁹ or NR¹⁰R¹¹; or
R¹² and R¹³ are halogen, CN, OR⁴, SR⁹, SOR⁹, SO₂R⁹ or NR¹⁰R¹¹, wherein the substituents OR⁴, SR⁹ or NR¹⁰R¹¹ optionally form 5- or 6-membered rings via the radicals R⁴, R⁹, R¹⁰ and/or R¹¹ with one of the carbon atoms of the phenyl, naphthyl, benzoyl or naphthoyl group or that of the substituent R^{3a}; or 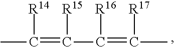
R¹² and R¹³ together are a group wherein R¹⁴, R¹⁵, R¹⁶ and R¹⁷ independently of one another are hydrogen, C₁-C₁₂alkyl optionally substituted by one or more halogen, phenyl, CN, —OH, —SH, C₁-C₄alkoxy, (CO)OH or (CO)O(C₁-C₄alkyl); or R¹⁴, R¹⁵, R¹⁶ and R¹⁷ are phenyl optionally substituted by one or more C₁-C₆alkyl, halogen, CN, OR⁴, SR⁹ or NR¹⁰R¹¹; or R¹⁴, R¹⁵, R¹⁶ and R¹⁷ are halogen, CN, OR⁴, SR⁹ or NR¹⁰R¹¹; or
R¹² and R¹³ together are a group 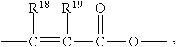
wherein R¹⁸ and R¹⁹ independently of each other are hydrogen, C₁-C₁₂alkyl optionally substituted by one or more halogen, phenyl, CN, —OH, —SH, C₁-C₄alkoxy, (CO)OH or (CO)O(C₁-C₄alkyl); or R¹⁸ and R¹⁹ are phenyl optionally substituted by one or more C₁-C₆alkyl, halogen, CN, OR⁴, SR⁹ or NR¹⁰R¹¹;
m is 1 or 2; and
Q is CO or a direct bond.

2. The polymerizable liquid crystal composition according to claim 1, wherein
R¹ is hydrogen, C₁-C₂₀-alkyl, C₁-C₆-alkyl-C₃-C₆-cycloalkyl, C₃-C₂₀-cycloalkyl, or C₂-C₁₂-alkenyl, wherein C₃-C₂₀-cycloalkyl or C₂-C₁₂-alkenyl is uninterrupted or interrupted by one or more O, S, CO, NR¹⁰ or COOR⁴;
R² is hydrogen, C₁-C₂₀-alkyl or C₁-C₆-alkyl-C₃-C₆-cycloalkyl which is unsubstituted or substituted by one or more halogen, OR⁴, SR⁹, COOR⁴CONR¹⁰R¹¹, NR¹⁰R¹¹, PO(OR^{3a})₂, COR^{3a},
R³ is hydrogen or C₁-C₂₀-alkyl;
R^{3a} is hydrogen or C₁-C₂₀-alkyl;
R⁴ is hydrogen, (CO)—R^{3a}, COOR^{4a}, CO NR^{10a}R^{11a}, S(O)ₘ—R^{3a} or PO(OR^{3a}) 2;
R^{4a} is hydrogen, C₁-C₂₀-alkyl, (CO)O(C₁-C₈-alkyl) or CON(C₁-C₈-alkyl)₂;
R⁵, R⁶, R⁷ and R⁸ independently of each other are hydrogen, C₁-C₂₀-alkyl, C₆-C₂₀-aryl, C₁-C₂₀-alkoxy, C₆-C₂₀-aryl C₁-C₂₀-alkyl, hydroxyl-C₁-C₂₀-alkyl, hydroxyl-C₁-C₂₀-alkoxy-C₁-C₂₀-alkyl, C₃-C₁₀-cycloalkyl, amino, CN, NO₂, hydroxy, 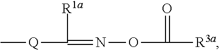
(CO)—R^{3a} OR^{4a} or COOR⁴;
R⁹ is hydrogen or C₁-C₂₀-alkyl;
R¹⁰ and R¹¹ independently of each other are hydrogen, C₁-C₂₀-alkyl, S(O)ₘ—R^{3a}, O(CO)—R^{3a} (CO)—R^{3a} or CONR^{10a}R^{11a}, and
R^{10a} and R^{11a} independently of each other are hydrogen, C₁-C₂₀alkyl, S(O)ₘ—(C₁-C₈alkyl), O(CO)(C₁-C₈alkyl), (CO)(C₁-C₈alkyl), (CO)O(C₁-C₈alkyl) or CON(C₁-C₈alkyl)₂; and
Q is CO or a direct.

3. The polymerizable liquid crystal composition according to claim 1, wherein the polymerization initiator of formula (I) is a compound of formula (Ia) or (Ib) 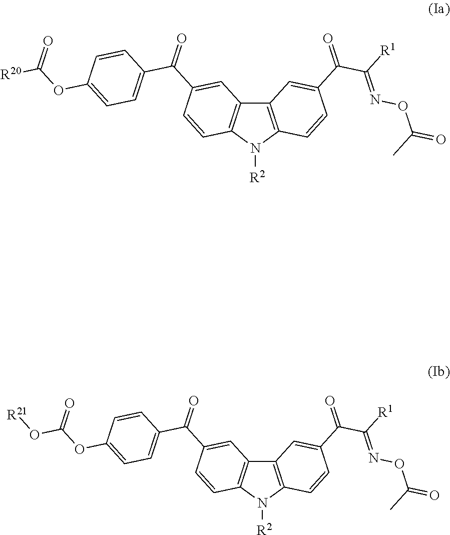
wherein
R¹ is linear C₁-C₈alkyl, in particular C₂-C₆alkyl;
R²⁰ and R²¹ independently of each other are C₁-C₂₀alkyl, C₆-C₂₀aryl or C₃-C₂₀heteroaryl, in particular C₁-C₈-alkyl.

4. The polymerizable liquid crystal composition according to claim 3, wherein the polymerization initiator of formula (Ia) is a compound of formula (Ia-1)

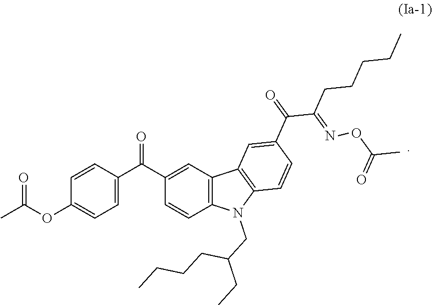 [SMILES: CCCCC/C(=N\OC(C)=O)C(=O)c1ccc2c(c1)c1cc(C(=O)c3ccc(OC(C)=O)cc3)ccc1n2CC(CC)CCCC]

5. The polymerizable liquid crystal composition according to claim 1, wherein the polymerizable liquid crystal compound is at least one anisotropic compound of formula (II) 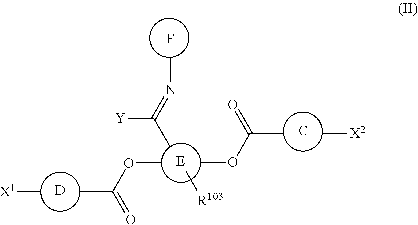
wherein
moieties C and D are independently from each other selected from the group consisting of phenyl, biphenyl, naphthyl, cycloalkyl, bicycloalkyl, 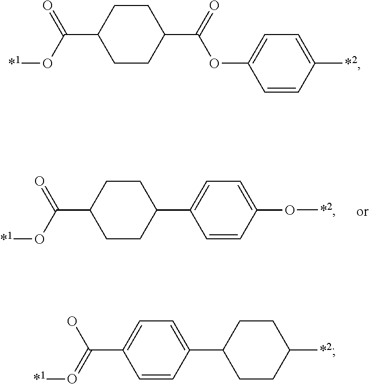
wherein *¹ represents the binding site of moiety C to X² and moiety D to X¹, respectively, and *² represents the binding site of moieties C and D to their neighbouring carboxyl groups bound to moiety E;
moiety E is selected from the group consisting of phenyl, biphenyl and naphthyl;
moiety F is selected from the group consisting of the groups of formulae (IIIa), (IIIb) or (IIIc) 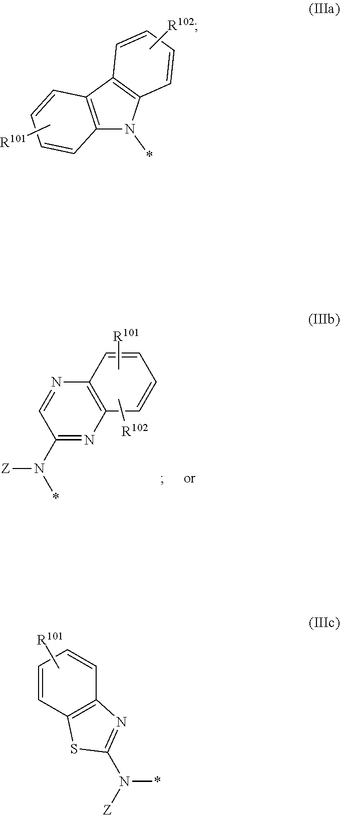
wherein * represents the binding site of moiety F to the imine nitrogen atom of formula II;
wherein at least one of X¹ and X² independently from each other are represented by the group of formula (IV) 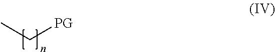
wherein n is an integer between 0 and 24, and wherein one or more C atoms may be replaced by —O—, —COO—, —OCO—, —OOC—, —O(CO)O—, —N—, —NR^{a}—, —CON—, wherein R^{a} is a C₁-C₁₂-alkyl group; and
PG represents a polymerizable group selected from the group consisting of CH₂—C(Ph)-, CH₂—CW—COO—, CH₂—CH—COO-Ph-, CH₂—CW—CO—NH—, CH₂═CH—O—, CH₂═CH—OOC—, Ph-CH═CH—, CH₂—CH-Ph-, CH₂═CH-Ph-O—, R^{b}-Ph-CH═CH—COO—, R^{b}—OOC—CH—CH-Ph-O— and 2-W-epoxyethyl; in which W represents H, Cl, Ph or a lower alkyl and R^{b} represents a lower alkyl with the proviso that when R^{b} is attached to a phenylene group (-Ph-) it may also represent hydrogen or a lower alkoxy,
and, where applicable, X¹ and X² which are not represented by the group of formula (IV) are selected from the group consisting of hydrogen, C₁-C₁₂ substituted or unsubstituted straight or branched alkyl chain, C₃-C₁₂ substituted or unsubstituted straight chain or branched alkenyl chain and C₁-C₁₂-alkoxy, wherein one or more carbon atoms may be replaced by —O—, —COO—,
—OCO—, —OOC—, —O(CO)O—, —N—, —NR^{a}—, —CON—, wherein R^{a} is a C₁-C₁₂-alkyl group;
Y is selected from the group consisting of H, or substituted or unsubstituted alkyl group having 1 to 12 carbon atoms;
R¹⁰¹, R¹⁰² and R¹⁰³ are independently from each other selected from the group consisting of hydrogen, C₁-C₁₂ straight or branched alkyl chain, C₃-C₁₂-alkenyl, C₁-C₁₂-alkoxy, C₃-C₁₂-alkenyloxy, —(CH₂)ₘ—C(CH₃)₃, NO₂, CN, COR¹⁰⁴, —COOR¹⁰⁴, OCOR¹⁰⁴, —CONR¹⁰⁵R¹⁰⁴, —NR¹⁰⁵COR¹⁰⁴, OCOOR¹⁰⁴, —OCONR¹⁰⁵R¹⁰⁴, —NR¹⁰⁵COOR¹⁰⁴, —F, —C₁, —CF₃ and —OCF₃; in which m is an integer between 0 and 12;
R¹⁰⁴ is selected from the group consisting of hydrogen, an C₁-C₁₈-alkyl group, an C₃-C₁₈-alkenyl group with the double bond at 3-position or higher, —(CH₂)P—C—(CF₃)₃, CN and unsubstituted or substituted phenyl ring, wherein the substituent of the phenyl ring is selected from the group consisting of C₁-C₆ straight or branched alkyl chain, C₁-C₆-alkoxy, —C—(CH₃)₃, halogen, —CF₃, NO₂, CN, COR¹⁰⁷, —COOR¹⁰⁷, —OCOR¹⁰⁷, —CONR¹⁰⁶R¹⁰⁷, —NR¹⁰⁶COR¹⁰⁷, OCOOR¹⁰⁷, —OCONR¹⁰⁶R¹⁰⁷, —NR¹⁰⁶COOR¹⁰⁷, —F, —C₁, —CF₃ and —OCF₃; in which
R¹⁰⁶ is selected from the group consisting of hydrogen, a lower alkyl group and a lower alkenyl group;
R¹⁰⁷ is selected from the group consisting of hydrogen, an C₁-C₁₈-alkyl group and an C₃-C₁₈-alkenyl group with the double bond at 3-position or higher; p is an integer between 0 and 12;
R¹⁰⁵ is selected from the group consisting of hydrogen, lower alkyl, lower alkenyl and lower alkoxy; and in which n is 0, 1, 2 or 3;
Z is selected from the group consisting of hydrogen, a substituted or unsubstituted alkyl group having 1 to 20 carbon atoms, a substituted or unsubstituted alkenyl group having 2 to 20 carbon atoms, a substituted or unsubstituted cycloalkyl group having 3 to 12 carbon atoms, a substituted or unsubstituted alkynyl group having 2 to 20 carbon atoms, wherein one or more carbon atoms may be replaced by —O—COO—, —OCO—, —OOC—, —O(CO)O—, —N—, —NR^{a}—, —CON—, —CO—R^{b1}, —NH—R^{c}, wherein R^{a} is a C₁-C₁₂-alkyl group, R^{b1} and R^{c} are independently from each other a substituted or unsubstituted alkyl group having 1 to 20 carbon atoms, or an organic group having 2 to 30 carbon atoms that includes at least one aromatic ring, or a substituted or unsubstituted alkenyl group having 2 to 20 carbon atoms, or a substituted or unsubstituted cycloalkyl group having 3 to 12 carbon atoms.

6. The polymerizable liquid crystal composition according to claim 5, wherein moiety F is a group of formula (IIIb) or (IIIc).

7. The polymerizable liquid crystal composition according to claim 5, wherein moieties C and D are independently from each other selected from phenyl or cyclohexyl, with the proviso that at least one moiety C or Dis phenyl.

8. The polymerizable liquid crystal composition according to claim 5, wherein moiety E is a phenyl ring.

9. The polymerizable liquid crystal composition according to claim 5, wherein at least one of the moieties C and D is an aromatic ring or contains an aromatic ring and the group of formula (IV) is 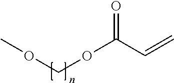
wherein n is an integer between 0 and 24.

10. The polymerizable liquid crystal composition according to claim 5, wherein R¹⁰¹, R¹⁰² and R¹⁰³ are independently from each other selected from the group consisting of hydrogen, and C₁-C₁₂ straight or C₃-C₁₂ branched alkyl chain.

11. The polymerizable liquid crystal composition according to claim 1, additionally comprising a polymerization inhibitor.

12. The polymerizable liquid crystal composition according to claim 1, additionally comprising a crosslinker selected from the group consisting of mono-, bi- and polyfunctional compounds containing at least one olefinic double bond and polythiols having two or more thiol groups per molecule.

13. A liquid crystal film which is a cured product of a polymerizable liquid crystal composition according to claim 1.

14. A process for manufacturing a liquid crystal film according to claim 13, comprising aligning the polymerizable liquid crystal compound to obtain a polymerizable liquid crystal layer in which the polymerizable liquid crystal compound has a predetermined orientation; polymerizing the polymerizable liquid crystal compound to form a network wherein the orientation of the liquid crystals is immobilized; and laminating the liquid crystal film onto a pressure sensitive adhesive coated onto a substrate.

15. A method of using a liquid crystal film, comprising manufacturing an optical device or an electro-optical device from the liquid crystal film according to claim 13.
